(19) United States
(12) Patent Application Publication
(10) Pub. No.: US 2026/0322918 A1
(43) Pub. Date: Oct. 15, 2026

(54) METHODS AND SYSTEMS FOR PRIORITIZING AN EMERGENCY INCIDENT QUEUE IN AN EMERGENCY MANAGEMENT APPLICATION

(71) Applicant: RAPIDSOS, INC., New York, NY (US)

(72) Inventor: Jamison Peevyhouse, Martin, TN (US)

(73) Assignee: RAPIDSOS, INC., New York, NY (US)

(21) Appl. No.: 19/437,936

(22) Filed: Dec. 31, 2025

Related U.S. Application Data
(60) Provisional application No. 63/787,491, filed on Apr. 11, 2025.

(51) Int. Cl. H04M 3/51; G10L 15/08

(52) U.S. Cl. CPC H04M 3/5116; G10L 15/08; G10L 2015/088; H04M 2242/04

(57) ABSTRACT

Methods, systems, and devices for integrating priority keywords into an emergency incident queue for emergency communications centers are described. In some implementations, a server may provide a user interface of an emergency management application operable by a computing system of one of multiple emergency communications centers. The server may receive emergency call data, including a call location and live call audio data associated with an emergency call, and may analyze the live call audio data to detect one or more keywords. The server may associate the detected keywords with the emergency call data and may display an incident queue of emergency incidents in the user interface. The server may update at least one of the emergency incidents in the queue to display the detected keywords, which may visually indicate a priority of the emergency call data associated with the emergency call to improve dispatcher efficiency and response prioritization.

### CROSS REFERENCE TO RELATED APPLICATIONS

The present Application for Patent claims the benefit of provisional patent application number 63/787,491 filed on Apr. 11, 2025, which is hereby incorporated by reference in its entirety.

### FIELD OF TECHNOLOGY

The present disclosure relates generally to emergency response, and more specifically to managing the priority of emergency incidents displayed in an emergency incident queue in an emergency response application.

### BACKGROUND

Emergency communication systems are widely used to manage and respond to incidents requiring immediate attention, such as medical emergencies, natural disasters, and public safety threats. These systems may include call centers, dispatch platforms, and communication networks that facilitate the transfer of information between public safety answering points and emergency response teams.

### SUMMARY

The described techniques relate to improved methods, systems, devices, and apparatuses that support techniques for integrating emergency contact retrieval and priority keyword detection in call management. Some implementations may address these challenges by integrating a provider registry with the contact center into the emergency management platform. This integration may enable automated retrieval of jurisdictional contact information, including 24-hour administrative phone numbers and physical addresses, based on the location of the incident. When a call may be routed to a center outside its jurisdiction, the system may query the database and display the relevant contact information directly within the user interface. This feature may provide dispatchers with immediate access to critical contact details, ensuring seamless coordination with other centers and reducing delays in emergency response.

In addition, some implementations may incorporate artificial intelligence to detect and display high-priority keywords directly in the call queue interface. The system may analyze real-time call audio to identify “Tier 1” keywords, such as “cardiac arrest” or “fire,” and may display these keywords prominently in the call queue. This may allow dispatchers to quickly identify and prioritize life-threatening incidents without the need to open individual call records. The platform may also include options for manual priority flagging, enabling telecommunicators to assign priority levels to calls based on their judgment. Furthermore, the system may support intelligent queue sorting, dynamically reorganizing the call queue to ensure that high-priority incidents are displayed at the top. These features may collectively enhance the efficiency and effectiveness of emergency response operations, particularly during high-volume events.

A method for integrating priority keywords into an emergency incident queue for ECCs is described. The method may include providing, by a server, a user interface of an emergency management application operable by a computing system of one of a plurality of ECCs. The method may include receiving, by the server, emergency call data including a call location and live call audio data associated with an emergency call. The method may include analyzing, by the server, the live call audio data to detect one or more keywords and associating the one or more keywords with the emergency call data. The method may include displaying, in the user interface of the emergency management application, an incident queue of emergency incidents associated with emergency calls received by the one of the plurality of ECCs. The method may include updating at least one of the emergency incidents to display the one or more keywords to visually indicate a priority of the emergency call data associated with the emergency call.

A system configured for integrating priority keywords into an emergency incident queue for emergency communications centers (ECCs) is described. The system may include a processor and a memory coupled with the processor. The memory may store instructions executable by the processor to cause the system to provide a user interface of an emergency management application that may be operable by a computing system of one of a plurality of ECCs. The system may receive emergency call data, which may include a call location and live call audio data associated with an emergency call. The system may analyze the live call audio data to detect one or more keywords and may associate the one or more keywords with the emergency call data. The system may display, in the user interface of the emergency management application, an incident queue of emergency incidents that may be associated with emergency calls received by the one of the plurality of ECCs. The system may update at least one of the emergency incidents to display the one or more keywords to visually indicate a priority of the emergency call data associated with the emergency call.

Another system for integrating priority keywords into an emergency incident queue for ECCs is described. The system may include means for providing a user interface of an emergency management application operable by a computing system of one of a plurality of ECCs. The system may include means for receiving emergency call data including a call location and live call audio data associated with an emergency call. The system may include means for analyzing the live call audio data to detect one or more keywords and associating the one or more keywords with the emergency call data. The system may include means for displaying, in the user interface of the emergency management application, an incident queue of emergency incidents associated with emergency calls received by the one of the plurality of ECCs. The system may include means for updating at least one of the emergency incidents to display the one or more keywords to visually indicate a priority of the emergency call data associated with the emergency call.

A non-transitory computer-readable medium storing code for integrating priority keywords into an emergency incident queue for ECCs is described. The code may include instructions executable by a processor to provide a user interface of an emergency management application operable by a computing system of one of a plurality of ECCs. The code may include instructions executable by a processor to receive emergency call data including a call location and live call audio data associated with an emergency call. The code may include instructions executable by a processor to analyze the live call audio data to detect one or more keywords and associate the one or more keywords with the emergency call data. The code may include instructions executable by a processor to display, in the user interface of the emergency management application, an incident queue of emergency incidents associated with emergency calls received by the one of the plurality of ECCs. The code may include instructions executable by a processor to update at least one of the emergency incidents to display the one or more keywords to visually indicate a priority of the emergency call data associated with the emergency call.

Some examples of the method, systems, and non-transitory computer-readable medium described herein may further include operations, features, means, or instructions for ranking the emergency incidents in the incident queue based on the detected one or more keywords and displaying the ranked emergency incidents in a sorted order within the user interface of the emergency management application.

Some examples of the method, systems, and non-transitory computer-readable medium described herein may further include operations, features, means, or instructions for associating a visual indicator with the one or more keywords in the incident queue. The visual indicator may include a color code selected from red, yellow, and green to represent different levels of priority.

Some examples of the method, systems, and non-transitory computer-readable medium described herein may further include operations, features, means, or instructions for querying a database to retrieve contact information for an ECC associated with the call location and displaying the contact information in the user interface of the emergency management application.

Some examples of the method, systems, and non-transitory computer-readable medium described herein may further include operations, features, means, or instructions for enabling a user to manually assign a priority level to the emergency incidents in the incident queue and updating the display of the incident queue to reflect the manually assigned priority level.

Some examples of the method, systems, and non-transitory computer-readable medium described herein may further include operations, features, means, or instructions for detecting a plurality of keywords in the live call audio data and grouping the emergency incidents in the incident queue based on the detected plurality of keywords to facilitate identification of related emergency incidents.

In some examples of the method, systems, and non-transitory computer-readable medium described herein, the one or more keywords may be categorized into predefined tiers based on their relevance to life-threatening emergencies, and the incident queue may be updated to display the tier associated with the emergency call data.

In some examples of the method, systems, and non-transitory computer-readable medium described herein, the incident queue may be configured to display a timestamp associated with the emergency call data to indicate the time the emergency call was received.

Some examples of the method, systems, and non-transitory computer-readable medium described herein may further include operations, features, means, or instructions for providing a filtering option in the user interface of the emergency management application to display emergency incidents based on the one or more keywords associated with the emergency call data.

In some examples of the method, systems, and non-transitory computer-readable medium described herein, the one or more keywords may be detected in response to analyzing the live call audio data for predefined phrases indicative of specific emergency types.

Some examples of the method, systems, and non-transitory computer-readable medium described herein may further include operations, features, means, or instructions for updating the incident queue to include a selectable option for initiating a direct communication with an ECC associated with the call location.

In some examples of the method, systems, and non-transitory computer-readable medium described herein, the user interface of the emergency management application may be configured to display a map with visual markers indicating the geographic locations of the emergency incidents in the incident queue.

### BRIEF DESCRIPTION OF THE DRAWINGS

FIG. 1 illustrates an example of a system for data processing that supports integrating emergency contact retrieval and priority keyword detection in call management in accordance with aspects of the present disclosure.

FIG. 2 shows an emergency management UI which supports techniques for integrating emergency contact retrieval and priority keyword detection in call management in accordance with various aspects of the present disclosure.

FIG. 3 shows incident queue UI which supports techniques for integrating emergency contact retrieval and priority keyword detection in call management in accordance with various aspects of the present disclosure.

FIG. 4 shows incident queue UI which supports techniques for integrating emergency contact retrieval and priority keyword detection in call management in accordance with various aspects of the present disclosure.

FIG. 5 shows incident queue UI which supports techniques for integrating emergency contact retrieval and priority keyword detection in call management in accordance with various aspects of the present disclosure.

FIG. 6 shows an ECC environment diagram which supports techniques for integrating emergency contact retrieval and priority keyword detection in call management in accordance with various aspects of the present disclosure.

FIG. 7 illustrates an example of a process flow that supports integrating emergency contact retrieval and priority keyword detection in call management in accordance with various aspects of the present disclosure.

FIG. 8 shows a block diagram of an apparatus that supports integrating emergency contact retrieval and priority keyword detection in call management in accordance with various aspects of the present disclosure.

FIG. 9 shows a block diagram of an emergency management component that supports integrating emergency contact retrieval and priority keyword detection in call management in accordance with various aspects of the present disclosure.

FIGS. 10A and 10B show block diagrams of an emergency response system in accordance with various aspects of the present disclosure.

FIG. 11 shows a diagram of a system including a device that supports integrating emergency contact retrieval and priority keyword detection in call management in accordance with various aspects of the present disclosure.

FIGS. 12 and 13 show flowcharts illustrating methods that support integrating emergency contact retrieval and priority keyword detection in call management in accordance with various aspects of the present disclosure.

### DETAILED DESCRIPTION

Methods, systems, devices, and apparatuses that support techniques for integrating emergency contact retrieval and priority keyword detection in call management are disclosed. In some examples, during high-volume emergency events, such as natural disasters or mass-casualty incidents, emergency communications centers may face significant challenges in managing call queues and coordinating with other jurisdictions. Dispatchers may often struggle to identify and prioritize life-threatening incidents due to the overwhelming number of calls and the inefficiency of existing systems. Current solutions may require manual review of individual call records to identify critical incidents, which may delay response times. Furthermore, when calls are routed out of jurisdiction, dispatchers may frequently lack immediate access to accurate contact information for the appropriate emergency communications centers or public safety answering points, creating additional delays in emergency response. These limitations may hinder the ability of emergency communications centers to respond effectively to emergencies, particularly in situations involving cross-jurisdictional coordination or non-contiguous call transfers.

In some implementations, a system may integrate a nationwide database of Emergency Communications Center contact information, referred to as the Enhanced PSAP Registry and Census (ERPC), into an emergency management platform. This database may include essential contact details, such as 24-hour, 10-digit emergency phone numbers and physical addresses for Emergency Communications Centers across the country. To identify the appropriate center for a given 911 call, the system may use a Jurisdictional Boundary File, which may map geographic areas to their respective Emergency Communications Centers. When a call may be identified as originating within a specific jurisdiction, the system may automatically query the database to retrieve the relevant contact information. This information may then be displayed to dispatchers when they hover over a call location or jurisdictional alert in the interface. Such functionality may provide a backup communication method, allowing dispatchers to directly contact the responsible Emergency Communications Center using the retrieved phone number, particularly in cases where the receiving center may not actively monitor the platform or may be located out of state. Additionally, the system may support calls rerouted from one jurisdictional Emergency Communications Center to another, providing tools to identify whether the call may be within the jurisdiction of the receiving center or if it may have been mistakenly or intentionally rerouted. For rerouted calls, the system may query the Enhanced PSAP Registry and Census database to retrieve the contact information for the jurisdictional Emergency Communications Center, displaying this information to the dispatcher for direct communication. The map interface may also display dynamic location markers to indicate whether an incident may be within or outside the jurisdiction of the receiving Emergency Communications Center, updating these markers in real time based on call routing and jurisdictional boundaries.

The system may incorporate artificial intelligence to enhance emergency call processing and prioritization. Artificial intelligence may analyze live 911 call audio in real time, transcribing and summarizing the audio while identifying critical keywords that may indicate high-priority incidents, such as “cardiac arrest,” “fire,” or “drowning.” These keywords may be displayed directly in the call queue interface beneath the caller's phone number or status, enabling dispatchers to quickly assess the nature of the emergency without opening individual call records. The list of keywords may be customizable, allowing dispatchers to define and update keywords based on local protocols, emerging incident trends, or specific needs of the Emergency Communications Center. Furthermore, the system may allow telecommunicators to manually assign priority levels to calls while they may be live, using numerical values such as Priority 1, 2, or 3, or color codes such as Red, Yellow, or Green. These manually assigned priority flags may be prominently displayed in the call queue, enabling other dispatchers or supervisors to quickly identify and address the most urgent calls. The system may also include features to dynamically sort and rank the call queue based on the presence of high-priority keywords or manually assigned priority flags. Calls with detected high-priority keywords may be automatically moved to the top of the queue or grouped together, while a sorting menu within the call queue interface may allow users to organize calls by keyword tagging, time, or priority level. This functionality may enable dispatchers to customize the queue view according to their operational needs, ensuring that critical incidents may be addressed promptly.

The call queue interface may be designed to display critical information in a clear and organized manner, enhancing dispatcher efficiency. This information may include the caller's phone number, location, incident time, detected keywords, and priority flags, all presented in a way that may streamline decision-making during emergencies. The interface may include a hover-over feature that may allow users to query the Enhanced PSAP Registry and Census database for jurisdictional contact information. When a user may hover over a “call routed” notification or jurisdictional alert, the system may display the 24-hour contact number and physical address of the responsible Emergency Communications Center. Additionally, the interface may include options for intelligent auto-sorting and filtering of incidents based on priority, keywords, or other criteria, allowing dispatchers to focus on the most urgent or relevant calls. The system may also provide a layer of redundancy by enabling direct communication with out-of-state or non-contiguous Emergency Communications Centers through the Enhanced PSAP Registry and Census database's 10-digit contact numbers. This functionality may ensure that dispatchers may coordinate effectively even if an Emergency Communications Center may not be using the emergency management platform or may be offline. Moreover, the system may include a map interface that may display incident locations, integrated with the incident queue to allow dispatchers to visualize the geographic distribution of incidents alongside their priority and keyword information. Dynamic location markers may be used to indicate whether an incident may be within or outside the jurisdiction of the Emergency Communications Center, updating these markers in real time based on call routing and jurisdictional boundaries.

Some implementations may allow users to define custom priority levels and keywords to address specific operational needs. Dispatchers may add custom keywords to the system's keyword detection list to account for unique local concerns or emerging incident types. The system may include a keyword tagging selection menu that may enable users to choose which types of incidents to tag based on live call audio. Users may enter custom keywords that may be of particular interest to their Emergency Communications Center, ensuring that the system may adapt to evolving requirements. Additionally, artificial intelligence algorithms may be used to rank and sort incidents based on the severity of detected keywords. Keywords may be ranked based on their importance, and incidents with top-tier keywords may be assigned higher priority. Incidents, based on keywords, may also trigger local authoritative protocol systems to further expedite the processing of the call. The system may include an intelligent auto-sort feature that may use algorithms or artificial intelligence to automatically prioritize and organize incidents in the queue based on their urgency. To further enhance usability, the system may include features to support dispatcher training on how to use the keyword alerting and priority flagging functionalities effectively. Mechanisms may be incorporated to minimize false positives in keyword detection, such as using combinations of keywords or proximity analysis to ensure that alerts may be accurate and relevant. These features may collectively improve the system's ability to handle emergencies efficiently while adapting to the specific needs of individual Emergency Communications Centers.

Aspects of the subject matter described in this disclosure can be implemented to realize one or more of the following potential advantages. The described techniques may be implemented to support enhanced situational awareness by enabling dispatchers to quickly identify and prioritize critical incidents through real-time keyword detection and dynamic queue management. The system may improve operational efficiency by reducing the time required to locate and address high-priority calls, which may be particularly beneficial during high-volume emergency events. The integration of jurisdictional boundary data and contact information may facilitate seamless communication between emergency centers, ensuring that calls may be routed and addressed accurately even in complex or cross-jurisdictional scenarios. The ability to customize keyword detection and priority levels may allow emergency centers to tailor the system to their specific needs, ensuring relevance and adaptability to local conditions. By incorporating redundancy through direct contact options and providing tools for manual prioritization, the system may enhance reliability and ensure that critical communication pathways remain accessible during emergencies.

Aspects of the disclosure are initially described in the context of networked computing systems. Aspects of the disclosure are additionally illustrated by and described with reference to example implementations. Aspects of the disclosure are further illustrated by and described with reference to apparatus diagrams, system diagrams, and flowcharts that relate to integrating emergency contact retrieval and priority keyword detection in call management.

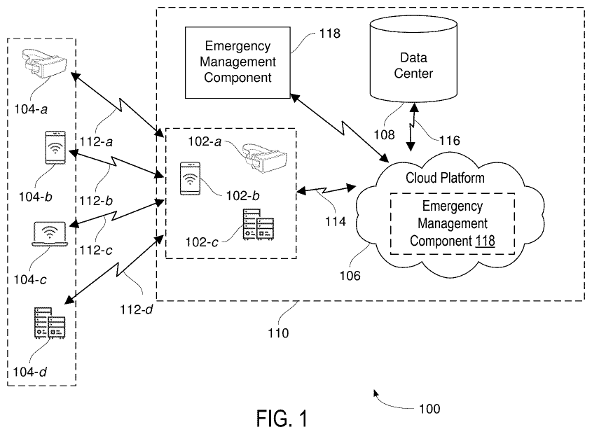

The disclosed systems and methods transform the technological area of emergency response management by addressing specific technical bottlenecks in call prioritization and cross-jurisdictional coordination. Traditional emergency management interfaces often require dispatchers to manually open and review individual call records to determine the nature and urgency of an incident—a process that is inherently slow and error-prone during high-volume emergency events or mass-casualty incidents. Furthermore, conventional systems lack the ability to bridge raw telephonic audio data with actionable visual queue management in real-time. The disclosed emergency response system overcomes these limitations by integrating automated, real-time artificial intelligence analysis of live call audio data to detect high-priority keywords and dynamically update a unified incident queue. This provides a technical improvement over manual systems by enabling ‘at-a-glance’ situational awareness and intelligent auto-sorting of life-threatening events (e.g., cardiac arrest or fire) ahead of non-critical data. Additionally, the system improves technological interoperability by integrating a jurisdictional provider registry that automates the retrieval of administrative contact information based on dynamic location markers, thereby reducing delays in cross-agency communication. Various embodiments of the disclosure are described hereafter and represented in FIGS. 1-13.

FIG. 1 illustrates an example of a system 100 that supports integrating emergency contact retrieval and priority keyword detection in call management in accordance with various aspects of the present disclosure. The system 100 includes cloud clients 102, user devices 104, a cloud platform 106, and a data center 108. Cloud platform 106 may be an example of a public or private cloud network. A cloud client 102 may access cloud platform 106 over a network connection 114. The network connection 114 may include a wired connection, a wireless connection, or both. The network may implement transfer control protocol and internet protocol (TCP/IP), such as the Internet, or may implement other network protocols. A cloud client 102 may be an example of a computing device, such as a wearable device (e.g., cloud client 102-a), a smartphone (e.g., cloud client 102-b), or a server (e.g., cloud client 102-c). In other examples, a cloud client 102 may be a desktop or laptop computer, a tablet, a sensor, or another computing device or system capable of generating, analyzing, transmitting, or receiving communications. In some examples, a cloud client 102 may be part of a business, an enterprise, a non-profit, a startup, or any other organization type. In some examples, the cloud client 102 includes call handling equipment of a PSAP or ECC.

A cloud client 102 may facilitate communication between the data center 108 and one or multiple user devices 104 to implement an online environment. The network connection 112 may include communications, opportunities, purchases, sales, or any other interaction between a cloud client 102 and a user device 104. The network connection 112 may include a wired connection, a wireless connection, or both. A cloud client 102 may access cloud platform 106 to store, manage, and process the data communicated via one or more network connections 112. In some cases, the cloud client 102 may have an associated security or permission level. A cloud client 102 may have access to certain applications, data, and database information within cloud platform 106 based on the associated security or permission level, and may not have access to others.

The user device 104 may be used to access various aspects of server system 110. The user device 104 may interact with the cloud client 102 over network connection 112. The network may implement transfer control protocol and internet protocol (TCP/IP), such as the Internet, or may implement other network protocols. The network connection 112 may facilitate transport of data via email, web, text messages, mail, or any other appropriate form of electronic interaction (e.g., network connections 112-a, 112-b, 112-c, and 112-d) via a computer network. In an example, the user device 104 may be a computing device such as a wearable device 104-a, a smartphone 104-b, a laptop 104-c or a server 104-d. Network connections may include telecommunications networks used to route a call (e.g., a 911 call) to an ECC. In other cases, the user device 104 may be another computing system. In some cases, the user device 104 may be operated by a user or group of users. The user or group of users may be a customer, associated with a business, a manufacturer, or any other appropriate organization.

Cloud platform 106 may offer an on-demand database service to the cloud client 102. In some cases, cloud platform 106 may be an example of a multi-tenant database system. In this case, cloud platform 106 may serve multiple cloud clients 102 with a single instance of software. However, other types of systems may be implemented, including—but not limited to—client-server systems, mobile device systems, and mobile network systems. In some cases, cloud platform 106 may support an online application (e.g., an emergency response data system, one or more emergency management applications, etc.). This may include emergency management services, analytics, such as user-interaction metrics, applications (e.g., computer vision, machine learning, AI, etc.), and the Internet of Things (IoT). Cloud platform 106 may receive data associated with generation of an online environment from the cloud client 102 over network connection 114, and may store and analyze the data. In some cases, cloud platform 106 may receive data directly from a user device 104 and the cloud client 102. In some cases, the cloud client 102 may develop applications to run on cloud platform 106. Cloud platform 106 may be implemented using remote servers. In some cases, the remote servers may be located at one or more data centers 108.

Data center 108 may include multiple servers. The multiple servers may be used for data storage, management, and processing (e.g., of various data sources and of emergency call data). Data center 108 may receive data from cloud platform 106 via connection 116, or directly from the cloud client 102 or via network connection 112 between a user device 104 and the cloud client 102. The connection 116 may include a wired connection, a wireless connection, or both. Data center 108 may utilize multiple redundancies for security purposes. In some cases, the data stored at data center 108 may be backed up by copies of the data at a different data center (not pictured).

Server system 110 may include cloud clients 102, a cloud platform 106, an emergency management component 118, and a data center 108 that may coordinate with cloud platform 106 and data center 108 to implement an online environment. In some cases, data processing may occur at any of the components of server system 110, or at a combination of these components. Thus, the emergency management component 118 may be included in the cloud platform 106, the server system 110, or in part or in whole in both. In some cases, servers may perform the data processing. The servers may be a cloud client 102 or located at data center 108.

Some or all of the functionality attributed to the emergency management component 118 may be embodied or performed by one or more components of server system 110 (e.g., cloud clients 102, a cloud platform 106, and/or a data center 108), and/or other components of system 100. The emergency management component 118 may receive signals and inputs from user device 104 directly, via cloud clients 102, and/or via cloud platform 106 or data center 108.

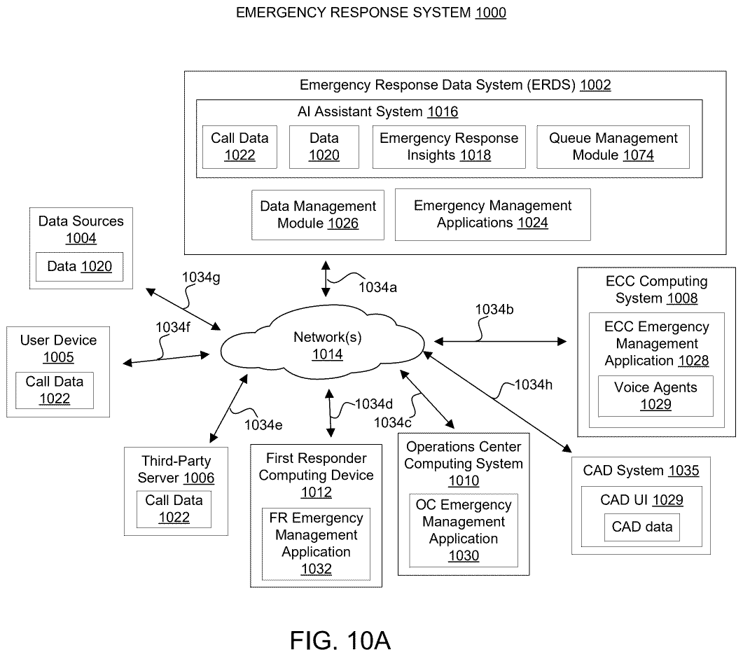

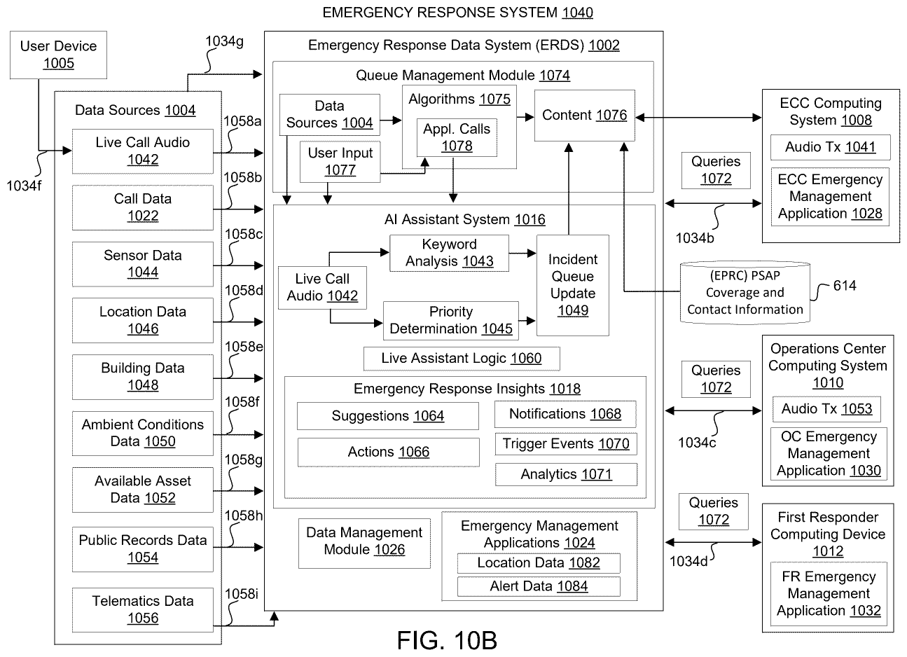

As described herein, some implementations may enable the emergency management component 118 to analyze live call audio data received from user devices 104 to detect keywords associated with emergency incidents. The detected keywords may be processed by server system 110, which may associate the keywords with corresponding emergency call data and update the incident queue displayed in the user interface of the emergency management application. The updated incident queue may visually indicate the priority of emergency calls based on the detected keywords, allowing for intelligent sorting and manual flagging of high-priority incidents. The emergency management component 118 may be operable to receive manual assignments of priority to incidents displayed in an incident queue in an emergency management application user interface (UI). The emergency management component 118 may be operable to retrieve and display contact information for other ECCs from, for example, Enhanced PSAP Registry and Census (EPRC) computing systems and/or databases. The emergency management component 118 is representative of a rerouted call module (e.g., shown in FIGS. 10A and 10B) and may also be operable to request and provide live 911 call audio transcriptions and summaries for selective sharing with one or more other ECCs, according to an embodiment.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

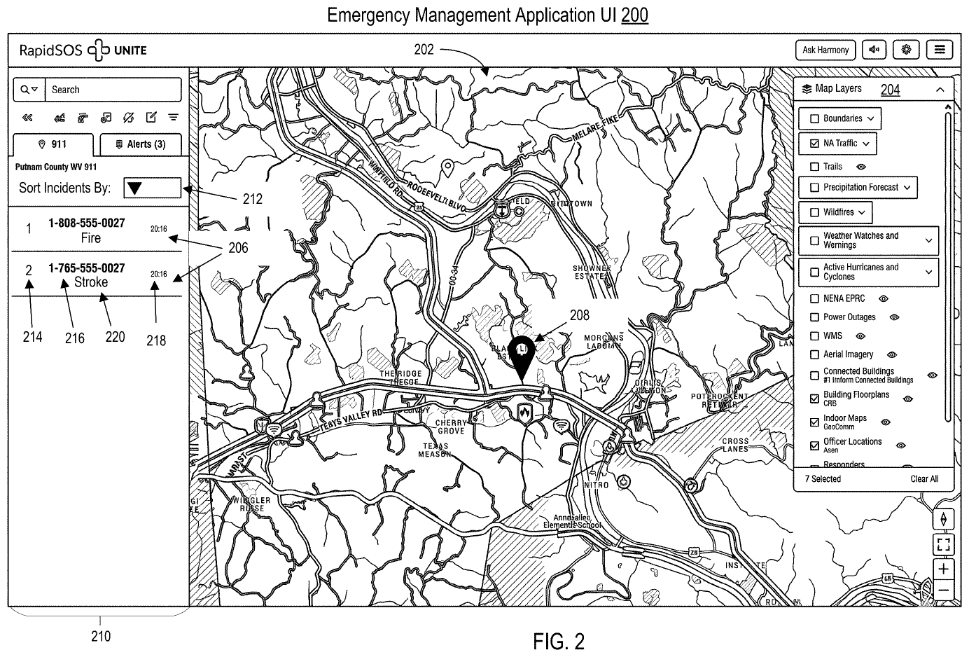

FIG. 2 shows emergency management application UI 200 which supports techniques for integrating emergency contact retrieval, priority keyword detection, keyword tagging, incident priority assignment, incident priority display, and manual or automated incident sorting in emergency call management in accordance with various aspects of the present disclosure. As depicted in FIG. 2, the emergency management application UI 200 may include one or more of a map 202, a map layers 204, incidents 206, a location pin 208, an incident queue 210, an incident sorting menu 212, an incident priority 214, a keyword tag 220 for an incident, and/or other components.

The map 202 may include a graphical representation of geographic areas relevant to emergency incidents. The map 202 may display boundaries of jurisdictions, roads, landmarks, and other geographical features that are significant to emergency response operations. The map 202 may be interactive, allowing users to zoom in and out or pan across different areas to gain a better understanding of the geographic context. The map 202 may be integrated with other components, such as the incidents 206 and the location pin 208, to visually represent the location of reported incidents. In some implementations, the map 202 may include overlays for weather patterns, traffic conditions, or other environmental factors that may influence emergency response.

The map layers 204 may include selectable options to display additional contextual information on the map 202. The map layers 204 may allow users to toggle between different types of data, such as jurisdictional boundaries, emergency service zones, or hazard areas. The map layers 204 may be configured to dynamically update based on real-time data feeds, such as weather alerts or traffic conditions. The map layers 204 may interact with the map 202 to enhance the visual representation of emergency incidents and their surrounding context. In some implementations, the map layers 204 may include specialized layers for specific types of emergencies, such as flood zones or wildfire perimeters. Map layers 204 may include a NENA EPRC selectable option to surface EPRC contact information and/or jurisdictional boundaries of ECCs and PSAPs, according to embodiments of the disclosure.

The incidents 206 represent emergency incidents that are called in or text messaged into an ECC. Incidents 206 may also represent incidents called into a business using the emergency management application for an operations center (e.g., a global security operations center). Visual markers or indicators representing locations (e.g., device-based hybrid location, ALI, etc.) of incidents 206 may be displayed on the map 202. Each of the incidents 206 may be displayed (e.g., within incident queue 210) with a telephone number 216, an incident time 218, a priority 214 (e.g., manually entered, AI generated, etc.), and/or a keyword tag 220, for example. The visual markers may be represented on map 202 as icons, symbols, and/or color-coded markers to indicate the type, severity, and/or jurisdiction of the emergency. The incidents 206 may be updated in real-time to reflect new reports or changes in the status of ongoing incidents. The incidents 206 may be displayed and organized by the incident queue 210, allowing users to access detailed information about each incident by selecting its corresponding marker on the map 202 or by selecting the incident from the incident queue 210. In some implementations, the incidents 206 may include additional visual cues, such as flashing or pulsing markers, to draw attention to high-priority events.

The location pin 208 may represent the specific geographic location of an individual incident on the map 202. The location pin 208 may be placed based on the coordinates of the reported incident, which may be determined through caller-provided information or automated location services (e.g., device-based hybrid location). The location pin 208 may include a tooltip or pop-up that displays key details about the incident, such as the type of emergency, time of report, and priority level. The location pin 208 may be visually distinct from other map elements to ensure it is easily identifiable. In some implementations, the location pin 208 may change in appearance based on the status or priority of the incident it represents. The location pin 208 may be represented differently when representing device-based hybrid location versus ALI location. The location pin 208 may also be represented differently when representing an out of jurisdiction location versus a location that is within the jurisdictional authority of an ECC, for example.

The incident queue 210 may include a list of reported incidents with associated details such as time, priority, and keywords. The incident queue 210 may be displayed in a tabular or list format, with each row or entry corresponding to a specific incident. The incident queue 210 may be updated in real-time to reflect new incidents or changes in the status of existing ones. The incident queue 210 may interact with the map 202 and the incidents 206, allowing users to select an entry in the queue to highlight its corresponding location on the map. In some implementations, the incident queue 210 may include additional fields, such as the name of the reporting party, the jurisdictional agent, and/or the responding agency. In one embodiment, if a call was rerouted to another jurisdiction, a symbol (e.g., a call forwarding symbol) may be displayed to represent the rerouting of the call (or text message). Call rerouting may occur for a number of reasons including, but not limited to, scheduled maintenance, an unscheduled outage, system malfunction (e.g., incorrectly routed to the wrong ECC, cybersecurity issues), and/or natural disaster (e.g., hurricane, tornado, inclement weather), for example.

The incidents sorting menu 212 may include options to organize the incident queue 210 based on various criteria such as time or priority. The incidents sorting menu 212 may allow users to select sorting parameters, such as ascending or descending order, to arrange the incident queue 210 in a way that aligns with their operational needs. The incidents sorting menu 212 may be configured to work dynamically, updating the order of incidents in real-time as new data is received. The incidents sorting menu 212 may interact with the incident queue 210 to ensure that the most relevant or urgent incidents are displayed prominently. In some implementations, the incidents sorting menu 212 may include additional sorting options, such as sorting by geographic proximity, incident type, keyword tag, assigned priority, time, redundant calls, resource availability (e.g., emergency responders distance to an incident), or the like.

The incident priority 214 may be assigned using tools that manually assign or adjust the priority level of incidents in the incident queue 210. The incident priority 214 may be assigned with a menu that allow users to select from predefined priority levels, such as high, medium, or low, 1, 2, or 3, green, yellow, or red, or assign custom priority labels. The incident priority 214 may be visible directly within the incident queue 210, enabling quick adjustments to priority levels as new information becomes available. The incident priority 214 may interact with the incidents sorting menu 212 to reorder the incident queue 210 based on the updated priority levels. In some implementations, the incident priority 214 may include visual indicators, such as color codes or icons, to represent different priority levels.

The keyword tag 220 may include configurable options to identify and display specific keywords associated with incidents in the incident queue 210. The keyword tag 220 may be defined by a menu or a predefined list of keywords that allow users to customize the list of keywords that the system monitors for during live call transcription and/or analysis. A menu for keyword tag 220 may be linked to the incident queue 210, enabling the display of detected keywords directly within the queue for each incident. The keyword tag 220 may interact with the incidents sorting menu 212 to allow users to organize the queue based on the presence of specific keywords. In some implementations, a menu for the keyword tag 220 may include options to prioritize certain keywords over others or to exclude irrelevant terms.

In some implementations, the map 202 may display incident locations relative to jurisdictional boundaries, with incidents 206 visually marked to indicate their geographic position. The location pin 208 may highlight a specific incident on the map 202, allowing dispatchers to quickly identify its proximity to other incidents or landmarks. The map layers 204 may enable users to toggle between different visual overlays, such as weather conditions, traffic patterns, or jurisdictional boundaries, to determine additional context for the incident.

In some implementations, the incident queue 210 may list active incidents alongside details such as the incident time, telephone number, and keyword tags. The incidents sorting menu 212 may allow users to organize the incident queue 210 based on criteria such as incident priority or keyword tagging. The incident priority 214 may be assigned with a menu that enables call-takers and/or dispatchers to manually assign urgency levels to incidents, which may then influence the order in which incidents appear in the queue. The keyword tag 220 may allow users to specify or customize keywords that may be flagged by AI transcription, which may assist in categorizing incidents within the queue.

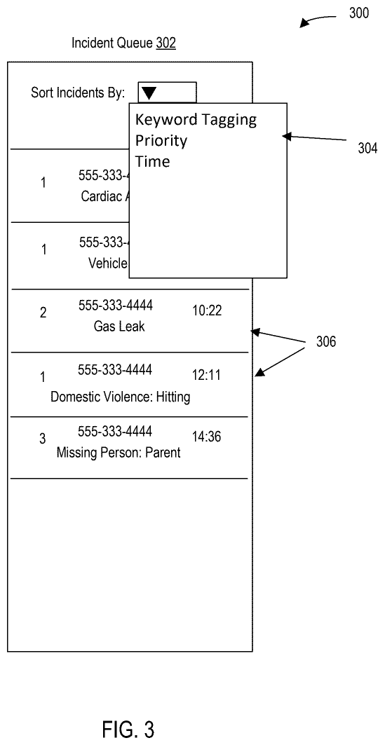

FIG. 3 shows incident queue UI 300 that supports techniques for integrating incident priority sorting in emergency call management in accordance with various aspects of the present disclosure. As depicted in FIG. 3, the incident queue UI 300 may include one or more of an incident queue 302, an incident sorting menu 304, incidents 306, and/or other components.

The incident queue 302 may include a list of active incidents displayed for call management. In some implementations, the incident queue 302 may be the same as or similar to the incident queue 210, as described herein.

The incident sorting menu 304 may include options to organize and arrange the incidents in the incident queue 302 based on specific criteria. In some implementations, the incident sorting menu 304 may be the same as or similar to the incidents sorting menu 212, as described herein. Example criteria include, but are not limited to, keyword tag, priority, time, distance to first responders, elapsed time since incident reporting, or the like.

The incidents 306 may represent individual emergency calls or events displayed within the incident queue 302. In some implementations, the incidents 306 may be the same as or similar to the incident 206, as described herein.

In some implementations, the incident queue 302 may display a list of incidents 306, each tagged with relevant information such as a telephone number, incident time, keyword tag (e.g., missing person, gas leak, domestic violence, vehicle fire, etc.) and priority level. The incident sorting menu 304 may be positioned above the incident queue 302 and may allow users to select sorting criteria, such as keyword tagging, priority, or time. The incidents 306 may dynamically rearrange within the incident queue 302 based on the selected sorting criteria, enabling dispatchers to view incidents in the desired order.

In some implementations, the incident sorting menu 304 may interact with artificial intelligence (AI) systems to determine the arrangement of incidents 306 within the incident queue 302. For example, AI may analyze live call audio to detect keywords and assign priority levels, which may then influence the sorting of incidents 306. The incident queue 302 may visually display these keywords and priority levels alongside the incident details, allowing dispatchers to interpret the information without opening individual records.

In some implementations, the incident queue 302 may include manual input options for dispatchers to assign or adjust priority levels for incidents 306. These adjustments may be reflected in real time within the incident queue 302, and the incident sorting menu 304 may allow users to reorganize the queue based on these manual priority assignments. The interaction between the incident queue 302, incident sorting menu 304, and AI systems may enable a dynamic and responsive interface for managing emergency calls.

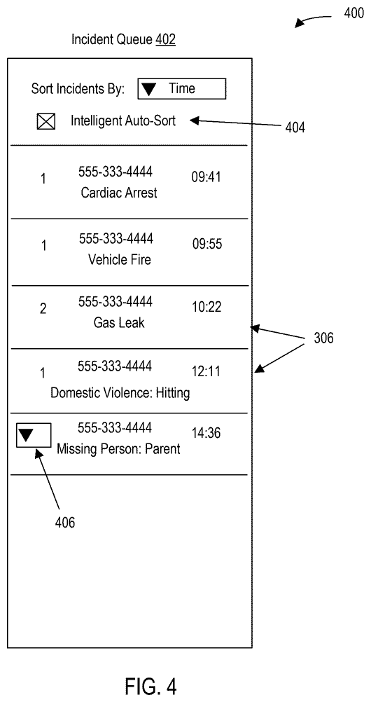

FIG. 4 shows incident queue UI 400 which supports techniques for advanced incident queue sorting and management in support of emergency call management in accordance with various aspects of the present disclosure. As depicted in FIG. 4, the incident queue UI 400 may include one or more of an incident queue 402, an intelligent auto-sort selection box 404, an incident priority menu 406, and/or other components.

The incident queue 402 may include a list of ongoing incidents with relevant details such as keywords, phone numbers, and incident times. In some implementations, the incident queue 402 may be the same as or similar to the incident queue 210 and/or incident queue 302, as described herein.

The intelligent auto-sort selection box 404 may allow users to enable one or more algorithms, AI systems, AI agents, and/or large language models (LLMs) to determine the sorting criteria for the incident queue based on factors such as priority, detected keywords, and/or content of live 911 calls (i.e., live call audio data). In some implementations, the intelligent auto-sort selection box 404 may be enabled by the queue management module 1074 and/or AI assistant system 1016, as described herein.

The incident priority menu 406 may enable users to manually assign priority levels to specific incidents within the incident queue. In some implementations, the incident priority menu 406 may include numeric, alphabetic, and/or color coordinated priority assignment, as described herein.

In some implementations, the incident queue 402 may display a list of incidents sorted by criteria selected through the intelligent auto-sort selection box 404. The intelligent auto-sort selection box 404 may allow users to activate algorithms and/or AI engines that dynamically arrange incidents based on priority levels or detected keywords. The incident priority menu 406 may enable manual assignment of priority levels to incidents, which may then influence the arrangement of incidents within the incident queue 402.

In some implementations, the incident queue 402 may visually represent incidents with associated details, such as phone numbers, incident times, keyword tags, and priority levels, which may be updated in real-time based on inputs from the intelligent auto-sort selection box 404 and the incident priority menu 406. The intelligent auto-sort selection box 404 may interact with the incident priority menu 406 to ensure that manually flagged incidents are appropriately ranked alongside those prioritized by AI-driven keyword detection.

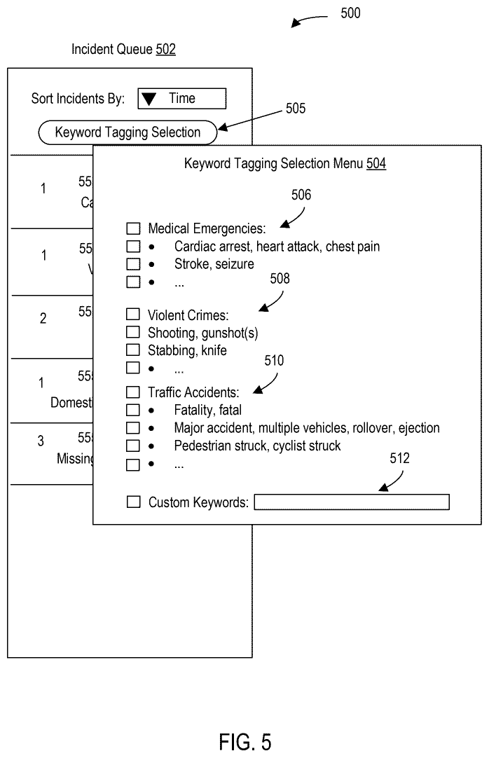

FIG. 5 shows an incident queue UI 500 that supports techniques for integrating advanced incident queuing in an emergency management application in accordance with various aspects of the present disclosure. As depicted in FIG. 5, the incident queue UI 500 may include one or more of an incident queue 502, a keyword tagging selection menu 504 accessible by a keyword tagging selection button 505, a first keyword category 506, a third keyword category 508, a second keyword category 510, a custom keyword entry option 512, and/or other components.

The incident queue 502 may display a list of ongoing incidents with relevant details for call management. In some implementations, the incident queue 502 may be the same as or similar to the incident queue 210, incident queue 302, and/or incident queue 402, as described herein.

The keyword tagging selection menu 504 may allow users to choose specific keywords or keyword categories for automatedly tagging incidents based on live call audio. Keyword tagging selection menu 504 may be displayed in response to selection of the keyword tagging selection button 505 or another type of UI element.

The first keyword category 506 may represent a predefined set of keywords related to life-threatening situations. The first keyword category 506 may include terms such as cardiac arrest, stroke, or severe bleeding, which may be identified as critical by the system. The first keyword category 506 may be preloaded into the system and may be customizable by the user to reflect specific needs or protocols. The first keyword category 506 may work in conjunction with the keyword tagging selection menu 504 to allow users to select or modify the keywords that are most relevant to their operations. In some implementations, the first keyword category 506 may include additional terms such as unconscious or unresponsive to address a broader range of life-threatening scenarios.

The second keyword category 510 may include keywords associated with traffic accidents and related emergencies. The second keyword category 510 may encompass terms such as major accident, pedestrian struck, or vehicle fire, which may be flagged during live call transcription. The second keyword category 510 may be organized to prioritize incidents involving traffic-related emergencies and may be updated based on local traffic patterns or historical data. The second keyword category 510 may be used in conjunction with the incident queue 502 to display relevant traffic-related incidents prominently. In some implementations, the second keyword category 510 may include additional terms such as rollover or ejection to address specific types of traffic accidents.

The third keyword category 508 may encompass keywords related to violent crimes. The third keyword category 508 may include terms such as shooting, gunshots, stabbing, knife, assault, battery, and/or robbery, which may be critical for identifying violent crimes. The third keyword category 508 may be preconfigured with commonly used terms but may allow users to add or remove keywords based on their specific operational requirements. The third keyword category 508 may interact with the keyword tagging selection menu 504 to enable users to prioritize incidents involving violent crimes. In some implementations, the third keyword category 508 may include additional terms such as kidnapping, homicide, murder, terrorist, etc. to encompass a larger range of violent crimes.

The custom keyword entry option 512 may enable users to define and input additional keywords tailored to specific needs or scenarios. The custom keyword entry option 512 may allow users to create unique keywords that are not included in the predefined categories, such as specific local landmarks or unique incident types. The custom keyword entry option 512 may be accessible through the keyword tagging selection menu 504, enabling users to seamlessly integrate their custom keywords into the system. In some implementations, the custom keyword entry option 512 may support the use of multiple languages or specialized terminology to accommodate diverse operational environments.

In some implementations, the incident queue 502 may display a list of incidents alongside sorting options that may allow users to organize incidents based on criteria such as time or keyword tagging. The keyword tagging selection menu 504 may be positioned adjacent to the incident queue 502 and may include selectable options for categorizing incidents based on predefined keyword categories. The first keyword category 506 may include medical emergencies, such as cardiac arrest or stroke, while the third keyword category 508 may include violent crimes, such as shootings or stabbings. The second keyword category 510 may include traffic accidents, such as major collisions or pedestrian-related incidents.

The example keyword categories are examples and are not intended to represent all types of categories. Other keyword categories may include but are not limited to fire and hazmat, other critical situations (e.g., active shooter, hostage, missing person, drowning, etc.), officer/responder safety, location and specific places (e.g., schools, government buildings, etc.), weapons and threats, mental health, and other potential keywords (e.g., “urgent”, “emergency”, “immediate help needed”, etc.)

In some implementations, the keyword tagging selection menu 504 may allow users to interact with checkboxes associated with the first keyword category 506, the second keyword category 510, and the third keyword category 508 to specify which types of incidents may be tagged in the incident queue 502. The custom keyword entry option 512 may be located within the keyword tagging selection menu 504 and may allow users to input specific keywords that may be relevant to their ECC's operational needs. When keywords are selected or entered, the incident queue 502 may dynamically update to display incidents tagged with those keywords, enabling users to sort and prioritize incidents based on the selected criteria.

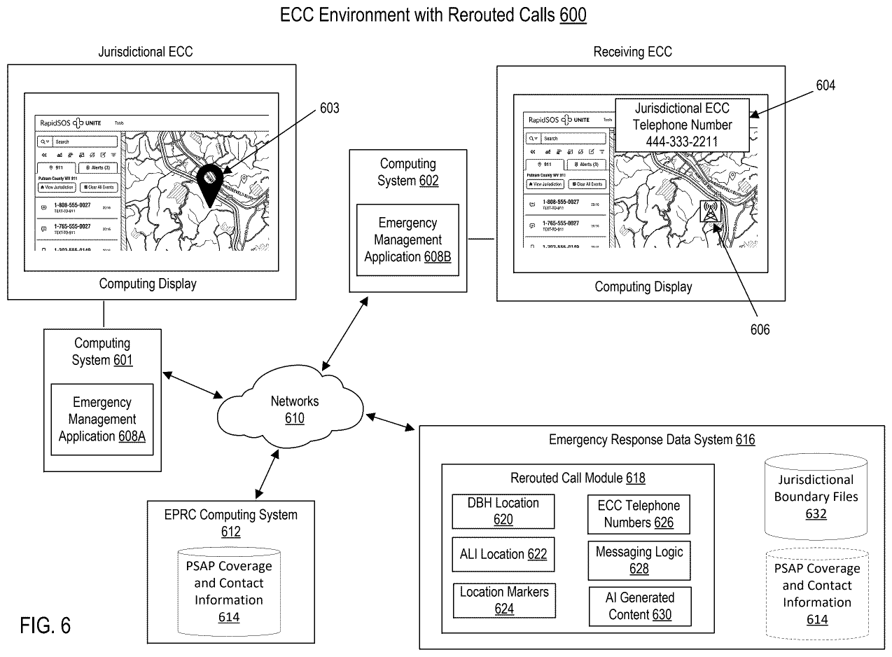

FIG. 6 shows ECC environment diagram 600 which supports techniques for integrating emergency contact retrieval and priority keyword detection in call management in accordance with various aspects of the present disclosure. As depicted in FIG. 6, the ECC environment diagram 600 may include one or more of a jurisdictional ECC computing system 601, a receiving ECC computing system 602, a jurisdictional ECC location marker 603, a jurisdictional ECC telephone number 604, a receiving ECC location marker 606 (e.g., that differs from the jurisdictional ECC location marker 603), an emergency management application 608A/608B, a network 610, an EPRC computing system 612, PSAP coverage and contact information 614 (database), an emergency response data system 616, a rerouted call module 618, a device-based hybrid (DBH) location 620, an automatic location identification (ALI) location 622, location markers 624, ECC telephone numbers 626, messaging logic 628, AI generated content 630, jurisdictional boundary files 632 (e.g., a database, table, or other data structure), and/or other components.

The jurisdictional ECC computing system 601 may include hardware and software configured to manage emergency calls within a specific jurisdiction. The jurisdictional ECC computing system 601 may consist of servers, databases, and communication interfaces that enable it to process and manage emergency call data. The jurisdictional ECC computing system 601 may be responsible for receiving, analyzing, and routing emergency calls to the appropriate responders within its designated geographic area. The jurisdictional ECC computing system 601 may interact with the jurisdictional boundary file 632 to determine the appropriate jurisdiction for a given emergency call. In some implementations, the jurisdictional ECC computing system 601 may include additional modules for handling rerouted calls or integrating with external systems such as the EPRC computing system 612.

The receiving ECC computing system 602 may represent a computing system of a receiving ECC that is a secondary emergency communications center capable of handling rerouted calls from other jurisdictions (e.g., a backup 911 call monitoring center). The receiving ECC computing system 602 may include systems and personnel trained to manage emergency calls that are transferred from a jurisdictional ECC due to overflow, technical issues, or other circumstances. The receiving ECC computing system 602 may process calls by accessing relevant data, such as the jurisdictional boundary file 632, to determine the appropriate response. The receiving ECC computing system 602 may communicate with the jurisdictional ECC computing system 601 through ERDS 616, emergency management applications 608, (e.g., messaging windows), and/or the network 610 to ensure seamless data exchange. In some implementations, the receiving ECC computing system 602 may include features for prioritizing and managing incidents that originate outside its primary jurisdiction.

The jurisdictional ECC location marker 603 may indicate the location of an emergency incident occurring within the geographic location of the jurisdictional ECC on a map interface. The jurisdictional ECC location marker 603 may be displayed as a visual icon or symbol on the map 202 within the emergency management application 608A. The jurisdictional ECC location marker 603 may assist users in identifying the physical location of incidents or other ECCs. In some implementations, the jurisdictional ECC location marker 603 may include customizable attributes, such as color or shape, to distinguish it from other markers on the map.

The jurisdictional ECC may be associated with the jurisdictional ECC telephone number 604 to provide additional contact information for the receiving ECC to directly contact the jurisdictional ECC to coordinate active incidents. ERDS 616 may populate emergency management application 608B with the jurisdictional ECC telephone number 604 based on one or more requests to the EPRC computing system 612, for example.

The jurisdictional ECC telephone number 604 may include a 10-digit contact number associated with the jurisdictional ECC. The jurisdictional ECC telephone number 604 may be stored in the EPRC computing system 612 and may be accessible through the emergency management application 608B (and/or 608A). The jurisdictional ECC telephone number 604 may allow users to establish direct communication with the jurisdictional ECC for coordination or information sharing. The jurisdictional ECC telephone number 604 may be displayed alongside the receiving ECC location marker 606 on the map interface. In some implementations, the jurisdictional ECC telephone number 604 may include additional metadata, such as operating hours or alternate contact methods.

The receiving ECC location marker 606 may represent the geographic location of the receiving ECC on a map interface. The receiving ECC location marker 606 may be displayed within the emergency management application 608B to indicate the position of the receiving ECC relative to other ECCs and incidents. The receiving ECC location marker 606 may assist users in visualizing the spatial relationship between the receiving ECC and the jurisdictional ECC. The receiving ECC location marker 606 may be linked to the ECC telephone number 626 to facilitate direct communication. In some implementations, the receiving ECC location marker 606 may include dynamic attributes, such as status indicators or operational capacity. The receiving ECC location marker 606 may indicate the location of a non-jurisdictional incident (e.g., an incident occurring within the jurisdiction of the jurisdictional ECC).

The emergency management application 608A/608B may include tools and features for managing and prioritizing emergency calls and incidents. The emergency management application 608 may provide a user interface that displays the incident queue 210, map 202, and other relevant data. The emergency management application 608 may integrate with the EPRC computing system 612 to access PSAP coverage and contact information 614. The emergency management application 608 may utilize the messaging logic 628 to enable communication between ECCs when a call is rerouted or during other times. In some implementations, the emergency management application 608A/608B may support additional functionalities, such as intelligent auto-sort selection box 404 or keyword tagging selection menu 504.

The networks 610 may facilitate communication and data exchange between the jurisdictional ECC computing system 601, the receiving ECC computing system 602, and other connected systems. The networks 610 may include wired and wireless communication channels that enable real-time data transmission and may include the Internet. The networks 610 may support the integration of external systems, such as the EPRC computing system 612, into the emergency management application 608. The networks 610 may ensure that the jurisdictional ECC computing system 601 and the receiving ECC computing system 602 can share incident data and updates. In some implementations, the networks 610 may include redundancy mechanisms (e.g., satellite communications) to maintain connectivity during high-demand scenarios.

The EPRC computing system 612 may include a database of PSAP coverage and contact information for emergency communications centers across the United States. The EPRC computing system 612 may store jurisdictional boundary files 632 that are privately defined or that are defined by a regulatory agency, including geographic boundaries and contact details for ECCs. The EPRC computing system 612 may interact with the emergency response data system 616 to provide relevant information during call routing or incident management. The EPRC computing system 612 may be accessible through the emergency management application 608 for querying ECC details. In some implementations, the EPRC computing system 612 may include advanced search capabilities to locate ECCs based on specific criteria, for example, through application programming interface (API) calls.

The PSAP coverage and contact information 614 may include jurisdictional boundaries, telephone numbers, and physical addresses for emergency communications centers. The PSAP coverage and contact information 614 may be stored in the EPRC computing system 612 and may be accessible through the emergency management application 608. The PSAP coverage and contact information 614 may assist users in identifying the appropriate ECC for a given incident or location. In some implementations, the PSAP coverage and contact information 614 may include additional details, such as operational status or resource availability.

The emergency response data system (ERDS) 616 may include modules and logic for processing and managing emergency call data. The emergency response data system 616 may analyze incoming live call data (e.g., using AI systems) to determine incident details and prioritize responses. The emergency response data system 616 may interact with the rerouted call module 618 to handle calls transferred between ECCs. The emergency response data system 616 may integrate with the AI generated content 630 to incorporate transcription, 911 call summaries, and keyword detection into incident management. In some implementations, the emergency response data system 616 may include customizable settings to adapt to specific ECC requirements.

The rerouted call module 618 may handle the redirection of emergency calls between jurisdictional and receiving ECCs. The functions of the rerouted call module 618 may include or overlap with operations of a queue management module that is disclosed herein. The rerouted call module 618 may determine the appropriate receiving ECC based on the jurisdictional boundary file 632 and PSAP coverage and contact information 614. The rerouted call module 618 may ensure that call data, such as location markers 624 and ECC telephone number 626, are displayed and provided accurately. The rerouted call module 618 may interact with the messaging logic 628 to facilitate communication between ECCs during call transfers. In some implementations, the rerouted call module 618 may include error-handling mechanisms to address rerouted and/or misrouted calls.

The DBH location 620 may represent a location determined based on GPS or other device based location determination hardware/software/firmware. The DBH location 620 may be used to identify patterns or trends in emergency incidents within a specific area. The DBH location 620 may interact with the jurisdictional boundary file 632 to verify jurisdiction of a particular. The DBH location 620 may be displayed on the map 202 within the emergency management application 608 (inclusive of 608A and 608B) for analysis. In some implementations, the DBH location 620 may include additional metadata, such as a person's name and a mobile carrier.

The ALI location 622 may include a location determined based on automatic location identification data. The ALI location 622 may be derived from caller-provided information or network-based location services. The ALI location 622 may be used to pinpoint the exact position of an emergency incident on the map 202. The ALI location 622 may interact with the location markers 624 to visually represent the incident's position. In some implementations, the ALI location 622 may include accuracy metrics to indicate the reliability of the location data.

The location markers 624 may represent the position of an incident or call on a map interface. The location markers 624 may be displayed within the emergency management application 608 to provide a visual reference for incident locations. The location markers 624 may be associated with the ALI location 622 or DBH location 620 to ensure accurate positioning. The location markers 624 may include attributes, such as icon type, color or shape, to indicate incident priority or status. In some implementations, the location markers 624 may include interactive features, such as hover-over details or links to additional information.

The ECC telephone numbers 626 may include contact numbers associated with emergency communications centers in a particular region (e.g., county, state, country, etc.). The ECC telephone numbers 626 may be stored in the EPRC computing system 612 and may be accessible through the emergency management application 608. The ECC telephone numbers 626 may allow users to establish direct communication with the corresponding ECC for coordination or information sharing. The ECC telephone numbers 626 may be displayed alongside the location markers 624 on the map interface. In some implementations, the ECC telephone numbers 626 may include additional metadata, such as operating hours or alternate contact methods.

The messaging logic 628 may include algorithms and processes for generating and managing communication between ECCs. The messaging logic 628 may facilitate the exchange of incident data, such as location markers 624 and AI generated content 630 (e.g., live call audio transcripts and/or summaries), between jurisdictional and receiving ECCs. The messaging logic 628 may be executed by the emergency response data system 616 to support accurate and timely communication. The messaging logic 628 may support various communication protocols, such as text, voice, or data messages. In some implementations, the messaging logic 628 may include features for tracking message delivery and response status.

The AI generated content 630 may include transcriptions, summaries, or keyword detections derived from emergency call audio. The AI generated content 630 may be created by analyzing real-time audio data from emergency calls. The AI generated content 630 may be displayed within the incident queue 210 to assist dispatchers in prioritizing and managing calls. The AI generated content 630 may interact with the emergency response data system 616 to enhance incident analysis and response planning. In some implementations, the AI generated content 630 may include customizable settings to adapt to specific ECC requirements.

The jurisdictional boundary files 632 may include data defining the geographic boundaries of jurisdictional ECCs. The jurisdictional boundary files 632 may be used to determine which ECC is responsible for a specific geographic area. The jurisdictional boundary files 632 may interact with the EPRC computing system 612 to ensure accurate mapping of jurisdictional boundaries. The jurisdictional boundary files 632 may be updated periodically to reflect changes in jurisdictional coverage or boundaries. In some implementations, the jurisdictional boundary files 632 may include additional data, such as population density or infrastructure details, to support incident management.

In some implementations, the jurisdictional ECC computing system 601 may interact with the emergency management application 608 to display the jurisdictional ECC location marker 603 and jurisdictional ECC telephone number 604 on the graphical interface. The receiving ECC computing system 602 may display the receiving ECC location marker 606, which may indicate the rerouted call's location relative to the jurisdictional boundary files 632. The network 610 may facilitate communication between the jurisdictional ECC computing system 601, the receiving ECC computing system 602, and the EPRC computing system 612, which may store PSAP coverage and contact information 614.

In some implementations, the emergency response data system 616 may integrate the rerouted call module 618 to determine the DBH location 620, ALI location 622, and location marker 624 for incidents. The ECC telephone number 626 may be retrieved from the EPRC computing system 612 and displayed alongside the jurisdictional ECC telephone number 604 when a user hovers over the incident. Messaging logic 628 may coordinate the display of AI-generated content 630, such as transcriptions or summaries, to assist in identifying incident priorities. The jurisdictional boundary file 632 may determine whether the incident falls within the jurisdiction of the receiving ECC or the jurisdictional ECC.

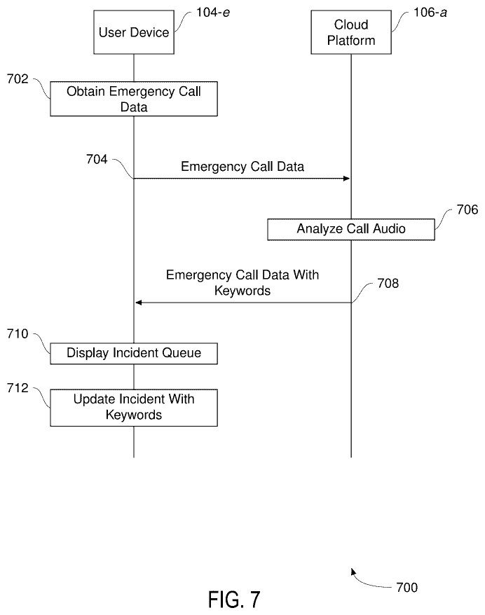

FIG. 7 illustrates an example of a process flow 700 that supports integrating incident queue prioritization and priority keyword detection in emergency call management in accordance with aspects of the present disclosure. In some examples, the process flow 700 may implement aspects of the system 100 and/or emergency response systems 1000 and 1040. For example, the process flow 700 may include a user device 104-e and a cloud platform 106-a, which may be examples of corresponding devices (e.g., an ECC computing system) described herein. In some implementations, a cloud platform 106-a analyzes live call audio data from emergency call data received via a user device 104-e (e.g., ECC computing system, ECC call handling equipment, etc.) to detect priority keywords, associates the keywords with the emergency call data, and updates an incident queue displayed on the user device 104-e to visually indicate the priority of the emergency call.

At 702, the user device 104-e may obtain emergency call data, including a call location and live call audio data associated with an emergency call. For example, the user device 104-e may receive the live call audio data from a 911 call or a text-based message to an ECC. In some implementations, the user device 104-e may determine the geographic coordinates of the call location by retrieving ALI data or by referencing a jurisdictional boundary file. The user device 104-e may further query a database, such as the EPRC, to retrieve additional information about the emergency call, including the contact details of the relevant emergency communications center.

At 704, the user device 104-e may transmit the emergency call data, including the call location and live call audio data, to the cloud platform 106-a. For example, the user device 104-e may package the emergency call data into a secure data packet before transmitting it to the cloud platform 106-a to ensure compatibility with the platform's data processing protocols. In some implementations, the user device 104-e may include metadata, such as a timestamp or the type of device used, as part of the transmitted data to assist the cloud platform 106-a in organizing and analyzing the information. The user device 104-e may transmit the data over a secure network connection, which may include encryption protocols to protect the integrity and confidentiality of the transmitted information. The user device 104-e may include an edge computing device communicatively coupled to other hardware devices.

At 706, the cloud platform 106-a may analyze the live call audio data to detect one or more keywords and may associate the one or more keywords with the emergency call data. For example, the cloud platform 106-a may identify keywords such as cardiac arrest, fire, or drowning from the live call audio data and may tag the emergency call data with these keywords for further processing. In some implementations, the cloud platform 106-a may rank the detected keywords based on predefined priority levels, such as categorizing cardiac arrest as a high-priority keyword. The cloud platform 106-a may also cross-reference the detected keywords with a predefined list of tiered keywords to determine their relevance to the emergency call data.

At 708, the cloud platform 106-a may transmit the emergency call data, including the detected one or more keywords, to the user device 104-e. For example, the cloud platform 106-a may package the emergency call data into a structured format, such as a JSON or XML file, to ensure compatibility with the user device 104-e. In some implementations, the cloud platform 106-a may include metadata, such as the timestamp of the keyword detection or the priority level of the associated keywords, as part of the transmitted data. The cloud platform 106-a may transmit the emergency call data over a secure communication channel, which may include encryption protocols to protect the data during transmission.

At 710, the user device 104-e may display, in a user interface of an emergency management application, an incident queue of emergency incidents that may be associated with emergency calls that may be received by the emergency communications center. For example, the incident queue may include keyword tags such as cardiac arrest or fire, which may be detected from live call audio and displayed directly under the caller's phone number. In some implementations, the user device 104-e may allow a user to manually assign a priority level, such as Priority 1, 2, or 3, to incidents in the queue, which may then be visually indicated with color codes like red, yellow, or green. The user interface may include a sorting option that may enable the user to organize the incident queue based on keyword tags, priority levels, or the time the emergency call was received.

At 712, the user device 104-e may update at least one of the emergency incidents in the incident queue to display the one or more keywords to visually indicate a priority of the emergency call data associated with the emergency call. For example, the user device 104-e may display keywords such as cardiac arrest or fire directly beneath the caller's phone number in the incident queue, allowing users to quickly identify the nature of the emergency. In some implementations, the user device 104-e may use color-coded indicators, such as red for high-priority incidents, to further emphasize the urgency of specific emergency calls. The user device 104-e may also allow users to customize the keywords displayed in the incident queue by selecting from a predefined list or entering additional keywords relevant to their specific operational needs. The user device 104-e may perform some of the described operations by executing the emergency management application that is provided by the emergency response data system.

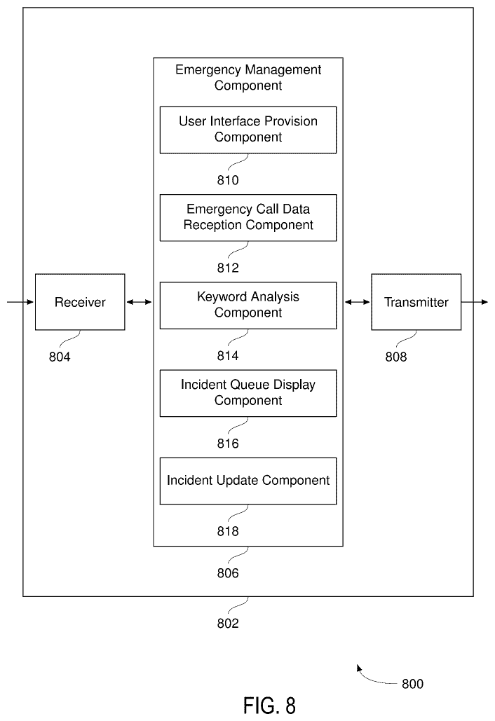

FIG. 8 shows a block diagram 800 of an apparatus 802 that supports integrating emergency contact retrieval and priority keyword detection in call management in accordance with various aspects of the present disclosure. The apparatus 802 may include an input module 804, emergency management component 806, and an output module 808. The apparatus 802 may also include a processor. Each of these components may be in communication with one another (e.g., via one or more buses). In some cases, the apparatus 802 may be an example of a user terminal, a database server, or a system containing multiple computing devices.

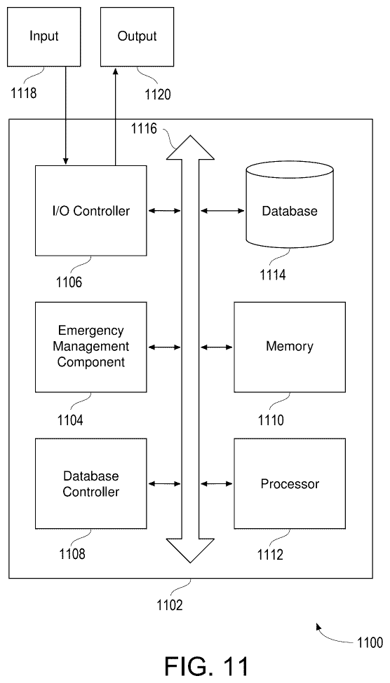

The input module 804 may manage input signals for the apparatus 802. For example, the input module 804 may identify input signals based on an interaction with a modem, a keyboard, a mouse, a touchscreen, or a similar device. These input signals may be associated with user input or processing at other components or devices. In some cases, the input module 804 may utilize an operating system such as iOS®, ANDROID®, MS-DOS®, MS-WINDOWS®, OS/2®, UNIX®, LINUX®, or another known operating system to handle input signals. The input module 804 may send aspects of these input signals to other components of the apparatus 802 for processing. In some cases, the input module 804 may be a component of an input/output (I/O) controller 1106 as described with reference to FIG. 11.

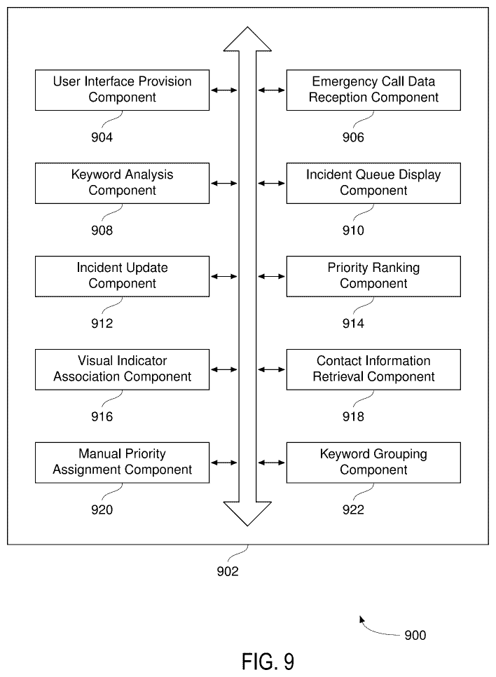

The emergency management component 806 may include one or more of a user interface provision component 810, an emergency call data reception component 812, a keyword analysis component 814, an incident queue display component 816, an incident update component 818, and/or other components. The emergency management component 806 may be an example of aspects of the emergency management component 902 or 1104 described with reference to FIGS. 9 and 10.

The user interface provision component 810 may be configured as or otherwise support a means for providing a user interface of an emergency management application operable by a computing system of one of a plurality of ECCs. The emergency call data reception component 812 may be configured as or otherwise support a means for receiving emergency call data, including a call location and live call audio data associated with an emergency call. The keyword analysis component 814 may be configured as or otherwise support a means for analyzing the live call audio data to detect one or more keywords and associating the one or more keywords with the emergency call data. The incident queue display component 816 may be configured as or otherwise support a means for displaying, in the user interface of the emergency management application, an incident queue of emergency incidents associated with emergency calls received by the one of the plurality of ECCs. The incident update component 818 may be configured as or otherwise support a means for updating at least one of the emergency incidents to display the one or more keywords to visually indicate a priority of the emergency call data associated with the emergency call.

The output module 808 may manage output signals for the apparatus 802. For example, the output module 808 may receive signals from other components of the apparatus 802, such as the emergency management component 806, and may transmit these signals to other components or devices. In some specific examples, the output module 808 may transmit output signals for display in a user interface, for storage in a database or data store, for further processing at a server or server cluster, or for any other processes at any number of devices or systems. In some cases, the output module 808 may be a component of an I/O controller 1106 as described with reference to FIG. 11.

FIG. 9 shows a block diagram 900 of an emergency management component 902 that supports integrating emergency contact retrieval and priority keyword detection in call management in accordance with various aspects of the present disclosure. The emergency management component 902 may be an example of aspects of an emergency management component 806, an emergency management component 1104, or both, as described herein. The emergency management component 902, or various components thereof, may be an example of means for performing various aspects of integrating emergency contact retrieval and priority keyword detection in call management as described herein. For example, the emergency management component 902 may include one or more of a user interface provision component 904, an emergency call data reception component 906, a keyword analysis component 908, an incident queue display component 910, an incident update component 912, a priority ranking component 914, a visual indicator association component 916, a contact information retrieval component 918, a manual priority assignment component 920, a keyword grouping component 922, and/or other components. Each of these components may communicate, directly or indirectly, with one another (e.g., via one or more buses).

The user interface provision component 904 may be configured as or otherwise support a means for providing a user interface of an emergency management application that may be operable by a computing system of one of a plurality of ECCs. In some implementations, the user interface provision component 904 may display an incident queue that may include keyword tagging for incidents based on live call audio. The user interface provision component 904 may allow users to interact with a graphical map interface to view jurisdictional boundaries and incident locations. In some implementations, the user interface provision component 904 may enable users to manually assign priority levels to incidents, such as Priority 1, 2, or 3, or through color codes like red, yellow, and green. The user interface provision component 904 may support a sorting menu that may allow users to organize incidents by criteria such as time, keyword tagging, or priority level. In some implementations, the user interface provision component 904 may include a hover-over feature that may display additional information, such as a 24-hour contact number and address for a specific ECC, based on the incident's jurisdiction.

The emergency call data reception component 906 may be configured as or otherwise support a means for receiving emergency call data that may include a call location and live call audio data that may be associated with an emergency call. In some implementations, the emergency call data reception component 906 may receive GPS coordinates to determine the precise location of the caller. In some implementations, the emergency call data reception component 906 may receive location data derived from cell tower triangulation or Wi-Fi access points. The emergency call data reception component 906 may process live call audio data to extract specific keywords that may indicate the nature of the emergency. In some implementations, the emergency call data reception component 906 may receive audio data in multiple languages and may support transcription in real time. In some implementations, the emergency call data reception component 906 may receive audio data with varying levels of clarity and may process it to identify intelligible segments.

The keyword analysis component 908 may be configured as or otherwise support a means for analyzing the live call audio data to detect one or more keywords and associating the one or more keywords with the emergency call data. In some implementations, the keyword analysis component 908 may detect keywords such as “cardiac arrest,” “fire,” or “vehicle accident” from the live call audio data. In some implementations, the keyword analysis component 908 may analyze audio data to identify phrases or terms that may indicate specific emergency scenarios, such as “help,” “injury,” or “trapped.” In some implementations, the keyword analysis component 908 may process audio data to identify keywords in multiple languages, such as Spanish, French, or Mandarin, to accommodate diverse callers.

The incident queue display component 910 may be configured as or otherwise support a means for displaying, in the user interface of the emergency management application, an incident queue of emergency incidents that may be associated with emergency calls received by the one of the plurality of ECCs. In some implementations, the incident queue display component 910 may display the incident queue with keyword tags that may be generated based on live call audio analysis. In some implementations, the incident queue display component 910 may present incidents with timestamps to indicate when the emergency calls were received. In some implementations, the incident queue display component 910 may allow users to view incident details, such as the caller's phone number or the jurisdictional ECC associated with the incident. In some implementations, the incident queue display component 910 may include a feature to highlight incidents with specific priority levels, such as Priority 1, 2, or 3, or color codes like red, yellow, and green. In some implementations, the incident queue display component 910 may support a search function that may allow users to locate specific incidents based on keywords or other criteria.

The incident update component 912 may be configured as or otherwise support a means for updating at least one of the emergency incidents to display the one or more keywords to visually indicate a priority of the emergency call data that may be associated with the emergency call. In some implementations, the incident update component 912 may display keywords such as “cardiac arrest” or “fire” in bold or highlighted text to draw attention to high-priority incidents. In some implementations, the incident update component 912 may use different font sizes or styles to distinguish between varying levels of priority, such as larger text for higher-priority incidents. In some implementations, the incident update component 912 may include a feature to categorize keywords into predefined tiers, such as Tier 1 or Tier 2, to reflect the urgency of the emergency call data. In some implementations, the incident update component 912 may allow users to customize the visual representation of keywords, such as by selecting specific colors or symbols to represent different types of emergencies. In some implementations, the incident update component 912 may support a feature to update the displayed keywords dynamically as new information is detected in the live call audio.

In some examples, the priority ranking component 914 may be configured as or otherwise support a means for ranking the emergency incidents in the incident queue based on the detected one or more keywords and may display the ranked emergency incidents in a sorted order within the user interface of the emergency management application. In some implementations, the priority ranking component 914 may rank incidents by assigning numerical values to keywords based on their urgency, such as assigning higher values to keywords like cardiac arrest or fire. In some implementations, the priority ranking component 914 may allow users to customize the ranking criteria by selecting specific keywords or categories that are relevant to their jurisdiction. In some implementations, the priority ranking component 914 may incorporate time-sensitive factors, such as the duration since the call was received, to adjust the ranking of incidents dynamically.

In some examples, the visual indicator association component 916 may be configured as or otherwise support a means for associating a visual indicator with the one or more keywords in the incident queue, wherein the visual indicator may include a color code selected from red, yellow, and green to represent different levels of priority. In some implementations, the visual indicator association component 916 may assign a flashing effect to the color code to draw attention to high-priority incidents. In some implementations, the visual indicator association component 916 may allow users to customize the intensity or shade of the color codes to align with specific jurisdictional preferences. In some implementations, the visual indicator association component 916 may support the use of additional visual elements, such as icons or symbols, to complement the color codes and further distinguish priority levels.

In some examples, the contact information retrieval component 918 may be configured as or otherwise support a means for querying a database to retrieve contact information for an ECC that may be associated with the call location and may display the contact information in the user interface of the emergency management application. In some implementations, the contact information retrieval component 918 may query a nationwide Enhanced PSAP Registry and Census database (EPRC) to determine the 24-hour emergency contact number for the ECC associated with the call location. In some implementations, the contact information retrieval component 918 may retrieve the physical address of the ECC and display it alongside the contact number in the user interface. In some implementations, the contact information retrieval component 918 may allow users to hover over a call location on a graphical map interface to trigger the display of the retrieved contact information.

In some examples, the manual priority assignment component 920 may be configured as or otherwise support a means for enabling a user to manually assign a priority level to the emergency incidents in the incident queue and may update the display of the incident queue to reflect the manually assigned priority level. In some implementations, the manual priority assignment component 920 may allow users to select priority levels such as high, medium, or low through a dropdown menu or a set of radio buttons. In some implementations, the manual priority assignment component 920 may support the use of color-coded indicators, such as red for high priority, yellow for medium priority, and green for low priority, to visually distinguish the assigned levels. In some implementations, the manual priority assignment component 920 may include an option for users to input custom labels or descriptions for priority levels to align with specific operational protocols.

In some examples, the keyword grouping component 922 may be configured as or otherwise support a means for detecting a plurality of keywords in the live call audio data and grouping the emergency incidents in the incident queue based on the detected plurality of keywords to facilitate identification of related emergency incidents. In some implementations, the keyword grouping component 922 may detect keywords such as “fire,” “explosion,” or “hazardous material” and group incidents involving these terms into a single category for easier review. In some implementations, the keyword grouping component 922 may group incidents by analyzing the context of the detected keywords, such as associating “cardiac arrest” with “chest pain” or “unconscious” to form a medical emergency category. In some implementations, the keyword grouping component 922 may support grouping incidents based on the geographic proximity of the detected keywords, such as clustering incidents that occur within a specific radius of a given location. In some implementations, the keyword grouping component 922 may allow users to define custom keyword categories, such as grouping incidents involving “domestic violence” and “assault” into a single category for specific monitoring.

FIGS. 10A and 10B illustrate example embodiments of an emergency response system that is operable to provide incident prioritization and EPRC integration in accordance with aspects of the disclosure. FIG. 10A illustrates a diagram of an emergency response system 1000 that includes an emergency response data system (ERDS) 1002 that is communicatively coupled to a number of data sources 1004, a user device 1005, a third-party server 1006, an ECC computing system 1008, an operations center (OC) computing system 1010, a first responder computing device 1012, and/or a CAD system 1035 through one or more networks 1014, according to an embodiment. ERDS 1002 is a data processing server that may be implemented as a cloud platform (e.g., cloud platform 106) and/or server system, according to an embodiment. Networks 1014 may include a number of wired networks, wireless networks, network components, and infrastructure. A number of communications channels 1034 (individually, 134a, 134b, 134c, 134d, 134e, 134f, 134g, and 135h) may communicatively couple the various components of emergency response system 1000.

Emergency response data system 1002 includes an artificial intelligence (AI) assistant system 1016 that is configured to support incident queue prioritization based on various call criteria, according to an embodiment. AI assistant system 1016 receives live call audio, analyzes the live call audio content to identify keywords, tag incidents with keywords, update the incident displayed in the incident queue to reflect the detected keywords, and/or sort the incident queue based on priorities of incidents, according to embodiments of the disclosure. AI assistant system 1016 may at least partially perform operations to support a rerouted call module and/or a queue management module 1074 that is operable to provide logic and/or algorithms that support incident prioritization.

Emergency response data system 1002 is also operable to generate emergency response insights 1018 from data 1020 and call data 1022, according to an embodiment. AI assistant system 1016 is operable to determine characteristics of call data 1022 and aggregate the characteristics with data 1020, according to an embodiment. AI assistant system 1016 is operable to analyze the aggregated characteristics with data 1020 to generate emergency response insights 1018, according to an embodiment. AI assistant system 1016 and/or emergency response data system 1002 may then provide emergency response insights 1018 to ECC computing system 1008, operations center computing system 1010, first responder computing device 1012 and/or CAD system 1035 for incident handling and/or receipt by emergency responders and/or emergency management personnel.

Emergency response data system 1002 is configured to host and/or support a number of emergency management applications 1024 that are accessed by and/or operated by ECC computing system 1008, operations center computing system 1010, and/or first responder computing device 1012, according to embodiments of the disclosure. Emergency response data system 1002 may be implemented with one or more servers that may be distributed across multiple data centers. Emergency management applications 1024 may be implemented on/in emergency response data system 1002 as web-based applications that are accessed via a web browser, a webhook, a persistent webhook, and/or one or more secure connections. Emergency management applications 1024 may be configured to process, push, and/or receive data to/from a mobile application or an operating system (OS) specific application that is downloaded to and operated by a particular computing system or device (e.g., a first responder smart phone). Data 1020 and call data 1022 may be retrieved, received, managed, and directed to AI assistant system 1016 and/or emergency management applications 1024 with a data management module 1026 to support generating and delivering emergency response insights 1018.

The various computing systems that receive emergency response insights 1018 are tools that may be used by emergency response personnel and emergency responders to dispatch, communicate about, and respond to incidents and emergencies that are represented by or in data 1020 and/or call data 1022, according to an embodiment. ECC computing system 1008 represents a computing system (e.g., a terminal, a server, a personal computer, a laptop, etc.) operated at or for an ECC. ECC computing system 1008 is configured to operate or provide an ECC emergency management application 1028. ECC emergency management application 1028 may be communicatively coupled to emergency response data system 1002 to receive emergency response insights 1018, data 1020, and/or call data 1022. ECC emergency management application 1028 may be configured with a graphical user interface to visually represent emergency events and incidents (e.g., using maps, queues, icons, data cards, etc.) and to enable emergency response personnel (e.g., 911 dispatchers, telecommunicators, etc.) to dispatch and communicate emergency events.

Operations center computing system 1010 represents a computing system (e.g., a terminal, a server, a personal computer, a laptop, etc.) operated at or for an operations center (e.g., a global operations security center (GSOC), a rail network operations center (NOC), etc.). Operations center computing system 1010 is configured to operate or provide/execute an operations center emergency management application 1030. The operations center emergency management application 1030 is an instance of emergency management applications 1024 that provides a graphical user interface to enable emergency response personnel (e.g., an operator, risk manager, security personnel, etc.) of corporations, other businesses, residences, academic institutions, and/or private entities to have awareness of incidents (e.g., emergency events) that occur on their particular premises or managed premises.

First responder computing device 1012 is representative of computing systems, mobile devices, and/or in-vehicle devices used by emergency responders to navigate to, coordinate for, and communicate about emergency events and other incidents, according to an embodiment. The term “first responder” may be used interchangeably with the term “field responder,” as used herein. First responder emergency management application 1032 may be operated on or by first responder computing device 1012. First responder emergency management application 1032 is communicatively coupled to emergency response data system 1002 to receive emergency response insights 1018, data 1020, and/or call data 1022 to inform the preparation and response to emergency events, according to an embodiment.

User device 1005 may include a telephone, a smart phone, tablet, a laptop, personal computer, a chrome book, or other computing devices that may be used, to initiate an emergency call (e.g., a 911 call) or to otherwise report an incident, according to an embodiment. Call data 1022 represents audio data, video, data, images, multimedia messages, location data (e.g., device-based hybrid (DBH) data), and/or text messages provided from user device 1005 to ECC computing system 1008 and/or operations center computing system 1010, according to an embodiment.

Third-party server 1006 may include a telecommunications or device manufacturer server that receives location data, user identification data, and/or call statistics for emergency calls made by user device 1005. Third-party server 1006 may be configured to provide call data 1022 to emergency response data system 1002 to support operation of emergency applications 1024, according to an embodiment. Call data 1022 may include device-based hybrid (DBH) data that may be provided by some telecommunications and/or smartphone companies.

CAD system 1035 is representative of a CAD program that receives CAD data and dispatches field/first responders. The CAD data may be at least partially displayed in CAD UI 1029 and may be extracted, conditioned, and/or reformatted from live call audio and/or using queue management module 1074, according to an embodiment. Examples of CAD programs include locally installed (e.g., at an ECC) and cloud-based programs such as, PremierOne CAD, Enterprise CAD, CAD Pro, Central Square CAD, CAD Pro, Unify, Versaterm CAD, ZOLL Dispatch, and the like.

FIG. 10B illustrates an example block diagram of an emergency response system 1040 that is operable to provide incident queue prioritization and/or interaction with ECC emergency management application 1028, in accordance with aspects of the disclosure. Emergency response system 1040 is an example implementation of emergency response system 1000, cloud platform 106, and/or system 100, in accordance with aspects of the disclosure.

Data sources 1004 may include one or more of a number of data types and data sources that may be used to identify, characterize, analyze or otherwise gain insights about emergency events and other incidents, according to an embodiment. Examples of data sources 1004 include, but are not limited to, live call audio 1042 (e.g., live 911 call audio data), call data 1022, sensor data 1044, location data 1046, building data 1048, ambient conditions data 1050, available asset data 1052 (e.g., air ambulance, drones, AED), public records data 1054, and/or telematics data 1056, according to an embodiment. Live call audio 1042 may be received by emergency response data system 1002 by configuring a call audio transmitter 1041 to forward/provide live call audio 1042, CDR, and/or ANI/ALI data from ECC call handling equipment (e.g., from ECC computing system 1008) and/or by configuring call audio transmitter 1053 to forward/provide live call audio 1042 from GSOC/NOC call handling equipment (e.g., from operations center computing system 1010), for example. Live call audio 1042 may also be routed to the emergency response system 1040 via session initiation protocol (SIP) audio ties into public and/or private telecommunications systems. Live call audio 1042 may also include radio-based dispatches or transcripts of radio-based dispatches of emergencies from an ECC.

Call data 1022 may include call duration, caller name, repeat call statistics, device-based location data, etc. of a call to an ECC or operations center. Call data 1022 may be at least partially retrieved from ECC computing systems and may include ANI (automatic number identification) data, ALI (automatic location identification) data, and/or CDR (call detail record) data. The ANI data is the phone number from which a 911 call or text to 911 originates. ALI data is the location information associated with the ANI data, and the ALI data may be retrieved from a database linked to the ANI data. CDR data is a detailed record of an incoming 911 call and may contain ANI data, the time the call came in, the time it was answered, any transfers, and the trunk number used. The position of a call-taker may also be included in the ANI data and/or the CDR data.

Sensor data 1044 may include, but is not limited to, data received or retrieved from residential buildings, commercial buildings, personal medical devices, personal safety devices, industrial structures, vehicles, crash detectors, smoke alarms, fire alarms, smart cameras, home security devices, moisture detectors, motion detectors, shock detectors, location sensors, gas detectors, pressure sensors, or the like, according to various embodiments of the disclosure.

Various other types of data may be received, acquired, and/or used. Location data 1046 may include a location of a sensor or incident (e.g., taken from a GPS unit of a smartphone). Building data 1048 may include construction materials, structure age, floorplans, renovation history, electrical schematics, HVAC layout, or the like. Ambient conditions data 1050 may include weather data, weather forecasts, road conditions, wind speeds, visibility, cloud conditions, temperature, or the like. Available asset data 1052 may include, but is not limited to, a number of available drones, a number of available medical devices (e.g., automated external defibrillator), a number of vehicles, a number of sprinklers in a building, or the like. Public records data 1054 may include, but are not limited to, personal property records, arrest records, residential addresses, etc. Telematics data 1056 may include various types of vehicle data, such as accelerometer data, gyroscope data, air bag sensors, vehicle log data, or the like. Additional miscellaneous data source or data types may include social media feeds, new feeds, geofence data, traffic feeds, visual impairment status, auditory impairment status, or the like. The various data sources 1004 may be communicatively coupled to emergency response data system 1002 through a number of communications channels 1058 (individually, 158a, 158b, 158c, 158d, 158e, 158f, 158g, 158h, and 158i), according to embodiments of the disclosure.

AI assistant system 1016 is operable to extract, analyze, condition, and/or format live call audio, CDR data, and/or ANI/ALI data to support incident queue prioritization and/or EPRC integration in accordance with aspects of the disclosure. CDR data may include position of call taker, time of call receipt, time of call answer, duration of call, etc. AI assistant system 1016 is operable as an AI agent, according to an embodiment. AI assistant system 1016 analyzes CDR data, other call data 1022, and/or live call audio 1042 with one or more LLMs, AI models, and/or with machine learning. Analysis of live call audio 1042 may include keyword analysis operations 1043 that prompt AI tools (e.g., LLMs, AI agent, AI models, machine learning, etc.) to perform audio analysis and incident characterization, according to an embodiment. AI assistant system 1016 may also include a priority determination operation 1045 to support automated incident queue prioritization, for example. AI assistant system 1016 may generate incident queue updates 1049 that are integrated into content 1076 for delivery to ECC management application 1028 for display to a call-taker, for example.

AI assistant system 1016 may also perform operations based on user input 1077. For example, keyword analysis operations 1043 may at least partially be based upon user selection of keywords, user input of keywords, and/or user upload of a keyword list, for example. Priority determination operation 1045 may be at least partially based on manual priority assignment of an incident by a user, based on selection of auto-sorting option by a user, and/or based on feedback on priorities provided by a user, for example.

AI assistant system 1016 may include a number of components to support generating emergency response insights 1018 for display by one or more of ECC emergency management application 1028, operations center emergency management application 1030, and/or first responder emergency management application 1032, according to an embodiment. AI assistant system 1016 may include live assistant logic 1060, which may include aspects of a retrieval, augmentation, generation (RAG) system, to generate emergency response insights 1018 based on call data 1022, data sources 1004, and/or trigger events 1070, in accordance with aspects of the disclosure.

Emergency response insights 1018 may include suggestions 1064, actions 1066, and/or notifications 1068 that are generated in response to one or more trigger events 1070, according to an embodiment. Emergency response insights 1018 may also include analytics 1071 that represent emergency communications statistics handled by an ECC, an operations center, and/or a first responder computing device at a particular location, for a region, and/or for a state or country. Emergency response insights 1018 may also include inferences (e.g., potential cause of an accident, potential health/mental/physical characteristics of an accident victim, etc.) about an emergency communication that may be derived based on LLM training and/or information contained within one or more data sources 1004. Suggestions 1064 may be displayed or transmitted to emergency applications 1024 to provide summaries, suggested actions (e.g., questions that align with SOPs for the particular ECC), additional awareness, or other insights to a dispatcher, telecommunicator, emergency management operator, or first responder, according to an embodiment. Suggestions 1064 may include, but are not limited to, 911 dispatcher codes, responder location, arrival times, pre-arrival instructions for first responders, severity of an incident (e.g., a severity score), live updates to incidents (based on live audio analysis and/or sensor data), medical procedures, documentation (e.g., standard operating procedures), response coordination, incident, characterization, and/or response suggestions, in accordance with various embodiments of the disclosure. Suggestions 1064 may also include AI generated search terms and/or search phrases that are based on historical context of a particular user, spatial context, and/or temporal context, for example. Suggestions 1064 may also include suggested actions, such as show traffic layer, dispatch to a particular location, display video feed layer, provide estimated time of arrival (ETA) of first responders, or other selectable actions. Emergency response data system 1002 may cause one or more suggestions 1064 to be displayed on a user interface of ECC emergency management application 1028, operations center emergency management application 1030, and/or first responder emergency management application 1032, according to various embodiments of the disclosure.

Actions 1066 are examples of actions that AI assistant system 1016 may, in coordination with emergency response data system 1002, initiate to facilitate a response to an emergency event. Actions 1066 may be at least partially performed on the client-side based on client-side emergency data processing that is at least partially supported by client-side resources, such as client-side local LLMs. Actions 1066 may include, but are not limited to, transfer calls (e.g., to an ECC having jurisdictional authority for a call), triage multiple calls (e.g., group, associate, combine, or summarize), call a point of contact (e.g., at a business location of an incident), cluster a group of calls or communications that are related to the same incident, automatedly respond to duplicate calls/texts about an emergency, search for a phone number of a point of contact, communicate with air ambulance server to dispatch an air ambulance, dispatch field responders to a location, display and/or populate protocol forms (e.g., intake protocol, cardiac-arrest protocol, chest pain protocol, drowning protocol, skin burn protocol, etc.), and/or generate a group chat or a group video conference between people who are located near or who are responding to a particular incident, according to various implementations of the disclosure. Actions 1066 may also include actions to manipulate and/or navigate the UI of an ECC or GSOC emergency management application. For example, actions 1066 may include enabling and displaying a particular layer, transmitting a digital request for resources (e.g., dispatching an air ambulance), requesting resources from an adjacent or nearby ECC, and/or sending emergency information to a computer aided dispatch (CAD) system.

Notifications 1068 may include informational content or alerts derived from a combination of the trigger events 1070, live call audio 1042, or other data sources 1004, in accordance with aspects of the disclosure. Notifications 1068 may include displaying particular insights about one or more related incidents, information about changes to an incident (e.g., a change of location, nature of a fire, number of victims, etc.), available asset updates, or the like. Notifications 1068 may include the status of a call, such as “rerouted to ECC xyz.”

Trigger events 1070 include events that may serve to initiate the aggregation of data sources 1004, analysis of data sources 1004, and/or the generation of emergency response insights 1018, according to an embodiment. Examples of trigger events 1070 may include, but are not limited to, a 911 call, a call to a rail NOC, a call to a GSOC, a text message to 911, a text message to a rail NOC, initiating a videoconference with 911, an activated alarm, a change in sensor data, a change in ambient condition data 1050 (e.g., an abnormal increase or decrease in temperature or moisture in a space), detection of a vehicle accident, airbag deployment, receipt of priority keywords, receipt of a priority assigned to an incident, receipt of a query 1072 from ECC computing system 1008, receipt of a query 1072 from an operations center computing system 1010, and/or receipt of a query from first responder computing device 1012, according to embodiments of the disclosure. Trigger events 1070 may also include telematics data associated with a vehicular accident or incident.

Analytics 1071 include various metrics for communications occurring at an ECC, a region of ECCs, a state of ECCs, one or more operations centers, and/or one or more other first responder devices or stations, in accordance with aspects of the disclosure. Analytics 1071 may also be used to generate supervisor reports that include missing incidents but that may include other information related to call handling (e.g., events that aren't necessarily missed but that occurred during a specified period of time. The metrics can cover areas such as call handling, resource management, and overall operational efficiency. The metrics may also include call answer times, abandonment rates, average handling time, and call volume trends to ensure service levels are being met and identify potential bottlenecks in the system. The metrics may also include incident response times and resource allocation to gauge the efficiency of emergency response coordination. As disclosed herein, AI assistant system 1016 may include one or more AI agents that may be configured to generate visualizations (e.g., charts, graphs, etc.) based on underlying context data, natural language questions, historical datasets, and/or forecasts.

Live assistant logic 1060 includes instructions, scripts, and/or one or more processes that support operations of AI assistant system 1016, according to an embodiment. For example, live assistant logic 1060 may be configured to communicate with queue management module 1074 and/or a reroute call module to receive and provide data for processing. Access to live assistant logic 1060 may be exposed to an ECC/GSOC end-user through an “ask AI” UI element in a UI for emergency management applications 1024, for example. Live assistant logic 1060 may be configured to provide extracted call characteristics/keywords and/or generated emergency response insights 1018 to emergency management applications 1024, for example. Live assistant logic 1060 may include or provide various application programming interfaces (API) to facilitate receipt of query 1072, according to an embodiment. Live assistant logic 1060 may include decision trees, flow diagrams, instructions, one or more AI agents, one or more large language models (LLMs), machine learning algorithms, or other processes to support live (real-time) interactions with human operators (e.g., call-taker, dispatcher, telecommunicator, operations center operator, first responder, etc.), according to an embodiment. The algorithms may include logic and/or decision trees and/or thresholds for rerouting calls and/or determining which voice agents to use in response to an incoming call.

Live assistant logic 1060 and/or AI assistant system 1016 may be implemented using one or more of a variety of technologies. Live assistant logic 1060 and/or AI assistant system 1016 may be a service that emergency response data system 1002 communicates with remotely or may include a number of libraries and software packages installed onto one or more local or distributed server (e.g., cloud) systems. Live assistant logic 1060 and/or AI assistant system 1016 may be at least partially distributed to a client-side emergency data processing system using, for example, a browser extension, a client-side application, a local LLM, a client-side operating system-based LLM, and/or a client-side networked LLM. Live assistant logic 1060 and/or AI assistant system 1016 may be implemented using transfer learning models that apply knowledge learned from one task to another, typically using pre-trained models. Examples of transfer learning models that may be used include, but are not limited to, BERT (bidirectional encoder representations from transformers): a transformer-based model for natural language processing tasks; GPT (generative pretrained transformer): a generative model for text-based tasks; and ResNet: a pre-trained deep learning model commonly used for image classification. Live assistant logic 1060 and/or AI assistant system 1016 may incorporate other types of models, such as deep learning models, unsupervised models, generative models, recommender systems, or the like. Examples of deep learning models may include convolutional neural networks (CNN), which may be used for image recognition tasks; recurrent neural networks (RNN), which may be used for sequential data, such as time series or natural language; and long short-term memory networks (LSTMN), for example.

Live assistant logic 1060 and/or AI assistant system 1016 may be implemented using one or more large language models (LLMs), according to an embodiment. LLMs are AI models that are trained to understand and generate human language. LLMs use large amounts of text data to learn patterns, context, and meaning in language. Examples of LLMs include, but are not limited to, generative pretrained transformers (GPTs), BERT, DistilBERT, T5 (Text-to-Text Transfer Transformer), XLNet, Turing-NLG, LLaMA (Large Language Model Meta AI), Claude, PaLM (Pathways Language Model), Megatron-Turing NLG, ChatGPT, OpenAI Codex, ERNIE (Enhanced Representation through Knowledge Integration), and/or Grok. In one embodiment, an LLM is trained on historical emergency response data (e.g., 911 call audio, emergency call audio, non-emergency call audio, sensor data, traffic data, weather data, field responder locations, telematics data, public records data, etc.), is operable to support ERDS 1002 operations, and is offered for download as a local LLM to ECC computing system 1008 and/or operations center computing system 1010.

Live assistant logic 1060 and/or AI assistant system 1016 may be at least partially implemented on a computing system that is local to the ECC to reduce latency in data transmission between an ECC and remote data processing servers. For example, live assistant logic 1060 and/or a RAG system may be implemented using a local LLM, allowing: content extraction live call audio and historical ECC data to be received from call handling equipment; on-premises data processing (e.g., image data, audio data, etc.); and low-latency re-insertion of information into the call handling equipment or to an ECC terminal. In accordance with various embodiments of the disclosure, a local implementation of live assistant logic 1060 may include installation in an edge device coupled to an ECC or GSOC network, installation of a local LLM, installation of a local application, and/or local installation of a browser extension that communicates with the local application and/or local LLM, for example.

Emergency management applications 1024 may provide location data 1082 and alert data 1084, in addition to emergency response insights 1018, according to an embodiment. Location data 1082 may include a device-based hybrid (DBH) location of an emergency event. The device-based hybrid location may be derived from call data 1022 and/or may be received from third-party server 1006. The device-based hybrid location may be based on GPS location of user device 1005 or based on registered locations of electronic devices in the vicinity of and communicatively coupled to user device 1005, according to various embodiments. Alert data 1084 may include alerts or notifications that are based on sensor data 1044 and/or one or more additional data sources 1004, according to an embodiment. Location data 1082 and/or alert data 1084 may be provided to and/or displayed by one or more of the emergency management applications 1028, 1030, and/or 1032, according to various embodiments.

Emergency response data system 1002 and AI assistant system 1016 may be configured to be responsive to queries 1072 (e.g., “Ask Harmony”, “Ask AI”, etc.) that may be entered into and received (from users) through any one of emergency management applications 1028, 1030, and/or 1032. Emergency response data system 1002 and AI assistant system 1016 are configured to be responsive to queries 1072 in the absence of a call-based trigger and/or a data-based trigger, according to an embodiment. Emergency management applications 1028, 1030, and/or 1032 may include a query input text box, may perform audio to text, or may receive and transmit audio to provide queries 1072 to AI assistant system 1016. AI assistant system 1016 may use queries 1072 as a trigger event 1070. AI assistant system 1016 may convert queries 1072 into a semantic vector to perform a vector search of a vector database, a content search of a vector database, and/or a hybrid vector-content search of a vector database. Queries 1072 may include queries related to summaries, graphs, charts, or other visualizations of analytics for an ECC, operations center, and/or first responder device/station, according to an embodiment. AI assistant system 1016 may provide responses to queries 1072 as emergency response insights 1018 and use similar UI elements in graphical user interfaces of emergency management applications 1028, 1030, and/or 1032.

ERDS 1002 includes a queue management module 1074 that is operable to support incident queue prioritization in accordance with aspects of the disclosure. Queue management module 1074 is operable to at least partially implement queue management based on received priorities, requests to sort the incident queue, extracted keywords from live call audio, and/or requests for automated queue sorting, for example. Queue management module 1074 may use algorithms 1075 to perform queue operations for selectively sorting and/or highlighting incidents based on keyword analysis operations 1043, priority determination operations 1045, and/or prioritization feedback received from a user. Queue management module 1074 may include application calls 1078 that interface with AI assistant system 1016. Queue management module 1074 may generate content 1076 that is displayed in emergency management applications 1024 (e.g., ECC emergency management application 1028, OC emergency management application 1030, FR emergency management application 1032). Content 1076 may include AI-generated summaries and/or transcripts of live call audio 1042. Content 1076 may include an incident queue sorting and/or incident queue updates. Content 1076 may also include one or more emergency response insights 1018, for example.

Algorithms 1075 may include decision trees, processes, methods, LLMs, and/or AI systems. Algorithms 1075 may be configured to cause the display one or more data cards having caller information. The caller information that is displayed may be automatically displayed for a particular phone number that a call-taker answers to respond to a 911 call. The caller information may include information such as location data 1046 that is representative of a location of a 911 call or a text to 911, which may be received from a third-party server 1006 (e.g., a telecommunications server), in accordance with aspects of the disclosure. The caller information may also include health information, name, weather information, caller history, first responder ETA, special standard operating procedures/instructions, or additional insights inferred from data sources 1004, for example. Upon receipt of additional data sources 1004 and/or user input 1077, algorithms 1075 may be configured to generate content 1076 (e.g., application calls 178, data cards, particular workflows, display of emergency response insights 1018, etc.) that may be transmitted to and/or displayed by ECC emergency management application 1028 and/or operations center emergency management application 1030, in accordance with various aspects of the disclosure. Various client-side components may be configured to interact with emergency management applications 1024 at the client using, for example, browser extensions, local applications, local LLMs, OS-based LLMs, and/or locally networked LLMs, according to embodiments.

ERDS 1002, queue management module 1074, and/or AI assistant system 1016 are operable to selectively request ECC contact information from PSAP coverage and contact information 614, according to an embodiment. ERDS 1002, queue management module 1074, and/or AI assistant system 1016 may use one or more API to interface with an EPRC computing system to retrieve ECC contact information. The ECC contact information may be automatically provided to a receiving ECC for a jurisdictional ECC, for example, when a call or incident is rerouted to a receiving ECC, as disclosed herein.

FIG. 11 shows a diagram of a system 1100 including a device 1102 that supports integrating emergency contact retrieval, incident queue management, and priority keyword detection in call management in accordance with aspects of the present disclosure. The device 1102 may be an example of or include the components of a database server or an apparatus 802 as described herein. The device 1102 may include components for bi-directional data communications including components for transmitting and receiving communications, including an emergency management component 1104, an I/O controller 1106, a database controller 1108, memory 1110, a processor 1112, and a database 1114. These components may be in electronic communication via one or more buses (e.g., bus 1116).

The emergency management component 1104 may be an example of an emergency management component 806 or 902 as described herein. For example, the emergency management component 1104 may perform any of the methods or processes described above with reference to FIGS. 8 and 9. In some cases, the emergency management component 1104 may be implemented in hardware, software executed by a processor, firmware, or any combination thereof.

The I/O controller 1106 may manage input signals 1118 and output signals 1120 for the device 1102. The I/O controller 1106 may also manage peripherals not integrated into the device 1102. In some cases, the I/O controller 1106 may represent a physical connection or port to an external peripheral. In some cases, the I/O controller 1106 may utilize an operating system such as iOS®, ANDROID®, MS-DOS®, MS-WINDOWS®, OS/2®, UNIX®, LINUX®, or another known operating system. In other cases, the I/O controller 1106 may represent or interact with a modem, a keyboard, a mouse, a touchscreen, or a similar device. In some cases, the I/O controller 1106 may be implemented as part of a processor. In some cases, a user may interact with the device 1102 via the I/O controller 1106 or via hardware components controlled by the I/O controller 1106.

The database controller 1108 may manage data storage and processing in a database 1114. In some cases, a user may interact with the database controller 1108. In other cases, the database controller 1108 may operate automatically without user interaction. The database 1114 may be an example of a single database, a distributed database, multiple distributed databases, a data store, a data lake, or an emergency backup database.

Memory 1110 may include random-access memory (RAM) and read-only memory (ROM). The memory 1110 may store computer-readable, computer-executable software including instructions that, when executed, cause the processor to perform various functions described herein. In some cases, the memory 1110 may contain, among other things, a basic input/output system (BIOS) which may control basic hardware or software operation such as the interaction with peripheral components or devices.

The processor 1112 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 1112 may be configured to operate a memory array using a memory controller. In other cases, a memory controller may be integrated into the processor 1112. The processor 1112 may be configured to execute computer-readable instructions stored in a memory 1110 to perform various functions (e.g., functions or tasks supporting emergency response system operations).

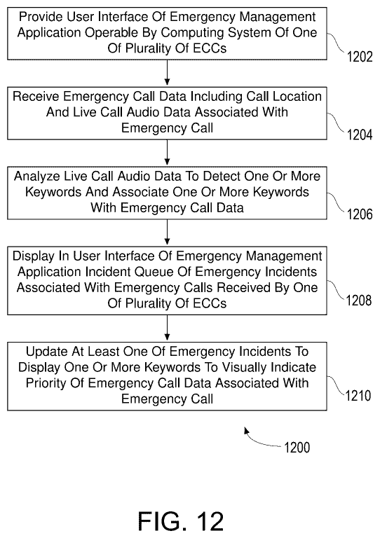

FIG. 12 shows a flowchart illustrating a method 1200 that supports integrating emergency contact retrieval and priority keyword detection in call management in accordance with various aspects of the present disclosure. The operations of the method 1200 may be implemented by one or more components of a networked computing system as described herein. For example, the operations of the method 1200 may be performed by an emergency management component as described with reference to FIGS. 8 through 11. In some examples, one or more components of a networked computing system may execute a set of instructions to control the functional elements of the component(s) to perform the described functions. Additionally or alternatively, the one or more components of a networked computing system may perform aspects of the described functions using special-purpose hardware.

At 1202, the method 1200 may include providing, by a server, a user interface of an emergency management application operable by a computing system of one of a plurality of ECCs. The operations of 1202 may be performed in accordance with examples as disclosed herein. In some examples, aspects of the operations of 1202 may be performed by a user interface provision component 904 as described with reference to FIG. 9.

At 1204, the method 1200 may include receiving, by the server, emergency call data including a call location and live call audio data associated with an emergency call. The operations of 1204 may be performed in accordance with examples as disclosed herein. In some examples, aspects of the operations of 1204 may be performed by an emergency call data reception component 906 as described with reference to FIG. 9.

At 1206, the method 1200 may include analyzing, by the server, the live call audio data to detect one or more keywords and associating the one or more keywords with the emergency call data. The operations of 1206 may be performed in accordance with examples as disclosed herein. In some examples, aspects of the operations of 1206 may be performed by a keyword analysis component 908 as described with reference to FIG. 9.

At 1208, the method 1200 may include displaying, in the user interface of the emergency management application, an incident queue of emergency incidents associated with emergency calls received by the one of the plurality of ECCs. The operations of 1208 may be performed in accordance with examples as disclosed herein. In some examples, aspects of the operations of 1208 may be performed by an incident queue display component 910 as described with reference to FIG. 9.

At 1210, the method 1200 may include updating at least one of the emergency incidents to display the one or more keywords to visually indicate a priority of the emergency call data associated with the emergency call. The operations of 1210 may be performed in accordance with examples as disclosed herein. In some examples, aspects of the operations of 1210 may be performed by an incident update component 912 as described with reference to FIG. 9.

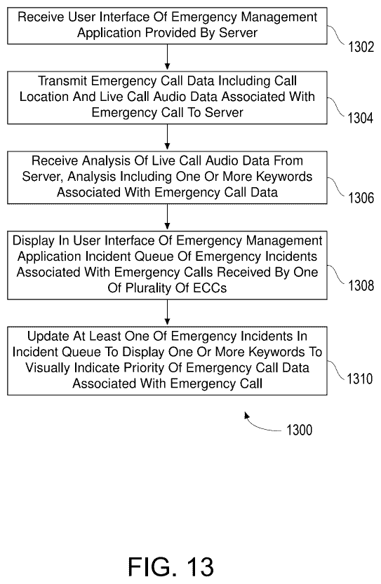

FIG. 13 shows a flowchart illustrating a method 1300 that supports integrating emergency contact retrieval and priority keyword detection in call management in accordance with various aspects of the present disclosure. The operations of the method 1300 may be implemented by one or more components of a networked computing system as described herein. For example, the operations of the method 1300 may be performed by an emergency management component as described with reference to FIGS. 8 through 11. In some examples, one or more components of a networked computing system may execute a set of instructions to control the functional elements of the component(s) to perform the described functions. Additionally or alternatively, the one or more components of a networked computing system may perform aspects of the described functions using special-purpose hardware. One or more of the operations of method 1300 may be partially performed by an emergency response system or emergency response data system, may be partially performed by an ECC computing system, and/or may be partially performed by an ECC server system (e.g., providing live call audio data to an edge device for transmission to the emergency response data system).

At 1302, the method 1300 may include receiving, by a computing system of one of a plurality of ECCs, a user interface of an emergency management application provided by a server. The operations of 1302 may be performed in accordance with examples as disclosed herein. In some examples, aspects of the operations of 1302 may be performed by a user interface provision component 904 as described with reference to FIG. 9.

At 1304, the method 1300 may include transmitting, by the computing system, emergency call data including a call location and live call audio data associated with an emergency call to the server. The operations of 1304 may be performed in accordance with examples as disclosed herein. In some examples, aspects of the operations of 1304 may be performed by an emergency call data reception component 906 as described with reference to FIG. 9.

At 1306, the method 1300 may include receiving, by the computing system, an analysis of the live call audio data from the server, the analysis including one or more keywords associated with the emergency call data. The operations of 1306 may be performed in accordance with examples as disclosed herein. In some examples, aspects of the operations of 1306 may be performed by a keyword analysis component 908 as described with reference to FIG. 9.

At 1308, the method 1300 may include displaying, by the computing system, in the user interface of the emergency management application, an incident queue of emergency incidents associated with emergency calls received by the one of the plurality of ECCs. The operations of 1308 may be performed in accordance with examples as disclosed herein. In some examples, aspects of the operations of 1308 may be performed by an incident queue display component 910 as described with reference to FIG. 9.

At 1310, the method 1300 may include updating, by the computing system, at least one of the emergency incidents in the incident queue to display the one or more keywords to visually indicate a priority of the emergency call data associated with the emergency call. The operations of 1310 may be performed in accordance with examples as disclosed herein. In some examples, aspects of the operations of 1310 may be performed by an incident update component 912 as described with reference to FIG. 9.

It should be noted that the methods described herein describe possible implementations, and that the operations and the steps may be rearranged or otherwise modified and that other implementations are possible. Furthermore, aspects from two or more of the methods may be combined.

Aspect 1: A method for integrating priority keywords into an emergency incident queue for emergency communications centers (ECCs), comprising: providing, by a server, a user interface of an emergency management application operable by a computing system of one of a plurality of ECCs; receiving, by the server, emergency call data including a call location and live call audio data associated with an emergency call; analyzing, by the server, the live call audio data to detect one or more keywords and associating the one or more keywords with the emergency call data; displaying, in the user interface of the emergency management application, an incident queue of emergency incidents associated with emergency calls received by the one of the plurality of ECCs; and updating at least one of the emergency incidents to display the one or more keywords to visually indicate a priority of the emergency call data associated with the emergency call.

Aspect 2: The method of aspect 1, further comprising ranking the emergency incidents in the incident queue based on the detected one or more keywords and displaying the ranked emergency incidents in a sorted order within the user interface of the emergency management application.

Aspect 3: The method of any of aspects 1 through 2, further comprising associating a visual indicator with the one or more keywords in the incident queue, wherein the visual indicator includes a color code selected from red, yellow, and green to represent different levels of priority.

Aspect 4: The method of any of aspects 1 through 3, further comprising querying a database to retrieve contact information for an ECC associated with the call location and displaying the contact information in the user interface of the emergency management application.

Aspect 5: The method of any of aspects 1 through 4, further comprising enabling a user to manually assign a priority level to the emergency incidents in the incident queue and updating the display of the incident queue to reflect the manually assigned priority level.

Aspect 6: The method of any of aspects 1 through 5, further comprising detecting a plurality of keywords in the live call audio data and grouping the emergency incidents in the incident queue based on the detected plurality of keywords to facilitate identification of related emergency incidents.

Aspect 7: The method of any of aspects 1 through 6, wherein the one or more keywords are categorized into predefined tiers based on their relevance to life-threatening emergencies, and the incident queue is updated to display the tier associated with the emergency call data.

Aspect 8: The method of any of aspects 1 through 7, wherein the incident queue is configured to display a timestamp associated with the emergency call data to indicate the time the emergency call was received.

Aspect 9: The method of any of aspects 1 through 8, wherein the user interface of the emergency management application includes a filtering option to display emergency incidents based on the one or more keywords associated with the emergency call data.

Aspect 10: The method of any of aspects 1 through 9, wherein the one or more keywords are detected in response to analyzing the live call audio data for predefined phrases indicative of specific emergency types.

Aspect 11: The method of any of aspects 1 through 10, wherein the incident queue is updated to include a selectable option for initiating a direct communication with an ECC associated with the call location.

Aspect 12: The method of any of aspects 1 through 11, wherein the user interface of the emergency management application is configured to display a map with visual markers indicating the geographic locations of the emergency incidents in the incident queue.

Aspect 13: A system for integrating priority keywords into an emergency incident queue for emergency communications centers (ECCs), comprising a processor; memory coupled with the processor; and instructions stored in the memory and executable by the processor to cause the system to perform a method of any of aspects 1 through 12.

Aspect 14: A system for integrating priority keywords into an emergency incident queue for emergency communications centers (ECCs), comprising at least one means for performing a method of any of aspects 1 through 12.

Aspect 15: A non-transitory computer-readable medium storing code for integrating priority keywords into an emergency incident queue for emergency communications centers (ECCs), the code comprising instructions executable by a processor to perform a method of any of aspects 1 through 12.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for integrating priority keywords into an emergency incident queue for emergency communications centers (ECCs), comprising:
providing, by a server, a user interface of an emergency management application operable by a computing system of one of a plurality of ECCs;
receiving, by the server, emergency call data including a call location and live call audio data associated with an emergency call;
analyzing, by the server in real time, the live call audio data of the emergency call while the emergency call is ongoing to detect one or more keywords from the live call audio data and associating the one or more keywords with the emergency call data;
displaying, in the user interface of the emergency management application, an incident queue of emergency incidents associated with emergency calls received by the one of the plurality of ECCs; and
updating at least one of the emergency incidents to display the one or more keywords to visually indicate a priority of the emergency call data associated with the emergency call.

2. The method of claim 1, further comprising ranking the emergency incidents in the incident queue based on the detected one or more keywords and displaying the ranked emergency incidents in a sorted order within the user interface of the emergency management application.

3. The method of claim 1, further comprising associating a visual indicator with the one or more keywords in the incident queue, wherein the visual indicator includes a color code selected from red, yellow, and green to represent different levels of priority.

4. The method of claim 1, further comprising querying a database to retrieve contact information from an enhanced PSAP registry and census (EPRC) database for an ECC associated with the call location and displaying the contact information in the user interface of the emergency management application.

5. The method of claim 1, further comprising enabling a user to manually assign a priority level to the emergency incidents in the incident queue and updating the incident queue in the user interface of the emergency management application to reflect the manually assigned priority level.

6. The method of claim 1, further comprising detecting a plurality of keywords in the live call audio data and grouping the emergency incidents in the incident queue based on the detected plurality of keywords to facilitate identification of related emergency incidents.

7. The method of claim 1, wherein the one or more keywords are categorized into predefined tiers based on their relevance to life-threatening emergencies, and the incident queue is updated to display a tier associated with the emergency call data.

8. The method of claim 1, wherein analyzing the live call audio data comprises:
providing the live call audio data to an artificial intelligence (AI) system;
providing a list of keywords to the AI system; and
providing instructions to the AI system to detect the one or more keywords from the live call audio data based on the list of keywords.

9. The method of claim 1, wherein the user interface of the emergency management application includes a filtering option to display emergency incidents based on the one or more keywords associated with the emergency call data.

10. The method of claim 1, wherein the one or more keywords are detected in response to analyzing the live call audio data for predefined phrases indicative of specific emergency types.

11. The method of claim 1, wherein the user interface of the emergency management application includes a selectable option for initiating a direct communication with an ECC associated with the call location.

12. The method of claim 1, wherein the user interface of the emergency management application is configured to display an option to automatically sort the incident queue, wherein an artificial intelligence (AI) system is instructed to sort the incident queue based on the one or more keywords detected while analyzing the live call audio data.

13. A system configured for integrating priority keywords into an emergency incident queue for emergency communications centers (ECCs), comprising:
a processor;
memory coupled with the processor; and
instructions stored in the memory and executable by the processor to cause the system to:
provide a user interface of an emergency management application operable by a computing system of one of a plurality of ECCs;
receive emergency call data including a call location and live call audio data associated with an emergency call;
analyze, in real time, the live call audio data of the emergency call while the emergency call is ongoing to detect one or more keywords from the live call audio data and associate the one or more keywords with the emergency call data;
display, in the user interface of the emergency management application, an incident queue of emergency incidents associated with emergency calls received by the one of the plurality of ECCs; and
update at least one of the emergency incidents to display the one or more keywords to visually indicate a priority of the emergency call data associated with the emergency call.

14. The system of claim 13, wherein the instructions are further executable by the processor to cause the system to: rank the emergency incidents in the incident queue based on the detected one or more keywords and display the ranked emergency incidents in a sorted order within the user interface of the emergency management application.

15. The system of claim 13, wherein the instructions are further executable by the processor to cause the system to: associate a visual indicator with the one or more keywords in the incident queue, wherein the visual indicator includes a color code selected from red, yellow, and green to represent different levels of priority.

16. The system of claim 13, wherein the instructions are further executable by the processor to cause the system to: query a database to retrieve contact information for an ECC associated with the call location and display the contact information in the user interface of the emergency management application.

17. The system of claim 13, wherein the instructions are further executable by the processor to cause the system to: enable a user to manually assign a priority level to the emergency incidents in the incident queue and update the display of the incident queue to reflect the manually assigned priority level.

18. The system of claim 13, wherein the instructions are further executable by the processor to cause the system to:
provide the live call audio data to an artificial intelligence (AI) system;
provide a list of keywords to the AI system; and
provide instructions to the AI system to detect the one or more keywords from the live call audio data based on the list of keywords to analyze the live call audio data.

19. The system of claim 13, wherein the instructions are further executable by the processor to cause the system to: categorize the one or more keywords into predefined tiers based on their relevance to life-threatening emergencies, and update the incident queue to display a tier associated with the emergency call data.

20. A non-transitory computer-readable medium storing code for integrating priority keywords into an emergency incident queue for emergency communications centers (ECCs), the code comprising instructions executable by a processor to:
provide a user interface of an emergency management application operable by a computing system of one of a plurality of ECCs;
receive emergency call data including a call location and live call audio data associated with an emergency call;
analyze, in real time, the live call audio data of the emergency call while the emergency call is ongoing to detect one or more keywords from the live call audio data and associate the one or more keywords with the emergency call data;
display, in the user interface of the emergency management application, an incident queue of emergency incidents associated with emergency calls received by the one of the plurality of ECCs; and
update at least one of the emergency incidents to display the one or more keywords to visually indicate a priority of the emergency call data associated with the emergency call.
